(19) United States
(12) Patent Application Publication
(10) Pub. No.: US 2007/0164987 A1
(43) Pub. Date: Jul. 19, 2007

(54) APPARATUS FOR HANDS-FREE SUPPORT OF A DEVICE IN FRONT OF A USER'S BODY

(76) Inventor: Christopher GRAHAM, Surrey (CA)

Correspondence Address: OYEN, WIGGS, GREEN & MUTALA LLP;480 - THE STATION, 601 WEST CORDOVA STREET, VANCOUVER, BC, V6B 1G1, US

(21) Appl. No.: 11/539,604

(22) Filed: Oct. 6, 2006

Related U.S. Application Data
(60) Provisional application No. 60/759,082, filed on Jan. 17, 2006.
(60) Provisional application No. 60/760,961, filed on Jan. 23, 2006.

(51) Int. Cl. G09G 5/00

(52) U.S. Cl. 345/156; 345/7

(57) ABSTRACT

An apparatus is disclosed for supporting an electronic device in front of the body of a user. The apparatus comprises a chest-engaging member, a first back-engaging member and at least one resiliently deformable first arm coupling the chest-engaging member to the first back-engaging member. Resilient deformation of the at least one first arm biases the chest-engaging member and the first back-engaging member toward one another. The apparatus also comprises a device-support assembly coupled to the chest-engaging member for supporting the device in front of the body of the user. The apparatus is adjustable to an expanded configuration wherein the device-support assembly extends forwardly from the chest-engaging member to support the device at a location that is forwardly spaced-apart from the chest-engaging member by a distance greater than about 12 cm. The apparatus is also adjustable to an intermediate storage configuration wherein the device-support assembly is collapsed to support the device at a location that is forwardly spaced-apart from the chest-engaging member by a distance less than about 8 cm.

### REFERENCE TO RELATED APPLICATION

This application claims the benefit of the filing dates of U.S. patent application No. 60/759,082 filed 17 Jan. 2006 and U.S. patent application No. 60/760,961 filed 23 Jan. 2006, both of which are hereby incorporated herein by reference.

### TECHNICAL FIELD

The present invention relates to apparatus for hands-free support of devices in front of a user's body. Particular embodiments provide compact and collapsible apparatus for supporting portable electronic devices and the like.

### BACKGROUND

Many people own and make use of portable electronic devices. Non-limiting examples of such portable devices include: personal desktop assistants (PDAs), cellular telephones, media storage devices, media playback devices, video game devices, portable email devices and the like. In many instances, it is desirable to be able to position portable electronic devices in front of a user's body so that the user can easily view or otherwise interact with the device. For example, a video playback device must generally be positioned in front of a user's body, so that the user can view the video images being played back on the device. As another example, a portable email device must generally be positioned in front of a user's body, so that the user can read incoming messages and can input text for outgoing messages.

There are also a number of portable electronic devices which must be positioned in front of a user such that the device can “view” or otherwise collect data from the user. Examples of such devices include devices that image the face, such as cameras for lip tracking or facial expression recognition.

There is a general desire for apparatus to support portable electronic devices and the like in front of a user's body.

An individual may want to use a portable electronic device for a long period of time. In addition, an individual may want to use his or her hands to operate the device or for some other application. In such circumstances, there is a desire for device-support apparatus capable of supporting device(s) in a hands-free manner. It is also desirable that the device-support apparatus is comfortable when supporting a portable electronic device for extended periods of use.

One of the principal advantages of portable electronic devices is their portability. Typically, portable electronic devices are lightweight and compact, so as to maintain their portability. Accordingly, it is desirable to provide device-support apparatus that are similarly lightweight and compact, compactable or otherwise collapsible, so as to be portable together with the device.

Portable electronic devices often contain sensitive components that are susceptible to damage from physical contact or from exposure to heat, moisture or radiation. For example, flat panel LCD displays which typically provide part of the principal user interfaces for portable electronic devices are particularly sensitive to physical contact. There is also a desire to provide some degree of protection for portable electronic devices against any of these and/or other potential sources of damage. In addition, it is generally desirable that device-support apparatus support portable electronic devices in a stable manner during user activity, so that the device is not damaged by falling to the ground.

There is a general need for an apparatus capable of supporting electronic devices in front of a user's body which addresses or at least ameliorates some of the issues discussed above.

### SUMMARY

A first aspect of this invention provides an apparatus for supporting an electronic device in front of the body of a user. The apparatus comprises a chest-engaging member, a first back-engaging member and at least one resiliently deformable first arm coupling the chest-engaging member to the first back-engaging member. Resilient deformation of the at least one first arm biases the chest-engaging member and the first back-engaging member toward one another. The apparatus also comprises a device-support assembly coupled to the chest-engaging member for supporting the device in front of the body of the user. The apparatus is adjustable to an expanded configuration wherein the device-support assembly extends forwardly from the chest-engaging member to support the device at a location that is forwardly spaced-apart from the chest-engaging member by a distance greater than about 12 cm. The apparatus is also adjustable to an intermediate storage configuration wherein the device-support assembly is collapsed to support the device at a location that is forwardly spaced-apart from the chest-engaging member by a distance less than about 8 cm.

The at least one resiliently deformable first arm may extend between the chest-engaging member and the first back-engaging member over at least one of the user's shoulders along a path that is spaced-apart from the at least one of the user's shoulders.

The device-support assembly may comprise a first pivot joint and the apparatus may be adjustable from the intermediate storage configuration to an intermediate viewing configuration by pivoting the first pivot joint. When the apparatus is in the intermediate viewing configuration, a first portion of the device may be forwardly spaced-apart from the chest-engaging member by less than about 5 cm and a second portion of the device may be forwardly spaced apart from the chest-engaging member by more than about 5 cm. When the apparatus is in the intermediate viewing configuration, a user interface of the device may be spaced forwardly from the chest-engaging member and oriented to display at least partially upwardly such that the user interface is viewable by the user.

When the apparatus is in the intermediate storage configuration: a user interface of the device may be generally aligned with at least one of: the chest-engaging member and the at least one first arm; and the user interface may be forwardly spaced-apart, by less than about 2 cm, from at least one of: the chest-engaging member and the at least one first arm.

The apparatus may comprise a device-mounting member for coupling the device to the device-support assembly. The device-mounting member may be adjustable to support the device in: a landscape configuration, wherein a first axis passing through a center of the device is oriented generally transversely and a second orthogonal axis passing through the center of the device is oriented at least partially vertically; and a portrait configuration, wherein the second orthogonal axis is oriented generally transversely and the first axis is oriented at least partially vertically. The device-mounting member may comprise a device-mounting pivot joint having a center of rotation which may be spaced-apart from the center of the device in a direction that is at least one of vertical and transverse. The center of rotation may be located at a point that is equally transversely and vertically spaced-apart from the center of the device.

The chest-engaging member may comprise a recess and, when the apparatus is in the intermediate storage configuration, the device-support assembly may be located in the recess. Alternatively, when the apparatus is in the intermediate storage configuration, the device-support assembly may be located forwardly of the device.

Another aspect of the invention provides an apparatus for supporting an electronic device in front of the body of a user. The apparatus comprises a chest-engaging member and means for supporting the chest-engaging member against a chest of the user. The apparatus also comprises a device-support assembly coupled to the chest-engaging member for supporting the device in front of the body of the user. The apparatus is adjustable to an expanded configuration wherein the device-support assembly extends forwardly from the chest-engaging member to support the device at a location that is forwardly spaced-apart from the chest-engaging member by a distance greater than about 12 cm. The apparatus is also adjustable to an intermediate storage configuration wherein the device-support assembly is collapsed to support the device such that a user interface of the device is generally aligned with the chest-engaging member and the user interface is forwardly spaced-apart from the chest-engaging member by less than about 2 cm.

The device-support assembly may comprise a first pivot joint. The apparatus may be adjustable from the intermediate storage configuration to an intermediate viewing configuration by pivoting the first pivot joint. When the apparatus is in the intermediate viewing configuration: a first portion of the device may be forwardly spaced-apart from the chest-engaging member by less than about 5 cm and a second portion of the device may be forwardly spaced apart from the chest-engaging member by more than about 5 cm; and the user interface may be spaced forwardly from the chest-engaging member and oriented to display at least partially upwardly such that the user interface is viewable by the user.

Another aspect of the invention provides an apparatus for supporting an electronic device in front of the body of a user. The apparatus comprises a chest-engaging member and first and second resiliently deformable arms respectively coupling the chest-engaging member to first and second back-engaging members. Resilient deformation of the first arm biases the chest-engaging member and the first back-engaging member toward one another and resilient deformation of the second arm biases the chest-engaging member and the second back-engaging member toward one another. The apparatus also comprises a device-support assembly coupled to the chest-engaging member for supporting the device in front of the body of the user. The first arm extends between the chest-engaging member and the first back-engaging member over a first one of the user's shoulders along a path that is spaced-apart from the first one of the user's shoulders and the second arm extends between the chest-engaging member and the second back-engaging member over a second one of the user's shoulders along a path that is spaced-apart from the second one of the user's shoulders.

The apparatus may be adjustable to an expanded configuration where the device-support assembly extends forwardly from the chest-engaging member to support the device at a location that is forwardly spaced-apart from the chest-engaging member by a distance greater than about 12 cm. The apparatus may be adjustable to an intermediate storage configuration where the device-support assembly is collapsed to support the device at a location that is forwardly spaced-apart from the chest-engaging member by a distance less than about 8 cm. The apparatus may be adjustable to an intermediate storage configuration wherein the device-support assembly is collapsed to support the device such that a user interface of the device is generally aligned with the chest-engaging member and the user interface is forwardly spaced-apart from the chest-engaging member by less than about 2 cm.

The device-support assembly may comprise a first pivot joint. The apparatus may be adjustable from the intermediate storage configuration to an intermediate viewing configuration by pivoting the first pivot joint. When the apparatus is in the intermediate viewing configuration: a first portion of the device may be forwardly spaced-apart from the chest-engaging member by less than about 5 cm and a second portion of the device may be forwardly spaced apart from the chest-engaging member by more than about 5 cm; and the user interface may be spaced forwardly from the chest-engaging member and oriented to display at least partially upwardly such that the user interface is viewable by the user.

Further aspects of the invention, further features of specific embodiments of the invention and applications of the invention are described below.

### BRIEF DESCRIPTION OF DRAWINGS

In drawings which show non-limiting embodiments of the invention:

FIG. 1A is a perspective view of a hands-free device-support apparatus according to a particular embodiment of the invention in its expanded configuration;

FIG. 1B is a different perspective view of the FIG. 1A device-support apparatus in its expanded configuration;

FIG. 1C is a perspective view of the FIG. 1A device-support apparatus in its intermediate viewing configuration;

FIG. 1D is a perspective view of the FIG. 1A device-support apparatus in its intermediate storage configuration;

FIG. 1E is a perspective view of the FIG. 1A device-support apparatus in a state between its intermediate storage configuration and its compact configuration;

FIG. 1F is a perspective view of the FIG. 1A device-support apparatus in its compact configuration;

FIG. 1G is a perspective view showing the FIG. 1A device-support apparatus in its expanded configuration on the body of a user;

FIGS. 2A-2F are schematic diagrams illustrating a number of forces that act at the contact point between the back-engaging members and a user's back for different relative heights of the chest-engaging member and back-engaging members and for different coefficients of friction;

FIG. 3A is a perspective view of a hands-free device-support apparatus according to a second embodiment of the invention in its expanded configuration;

FIG. 3B is a perspective view of the FIG. 3A device-support apparatus in its intermediate viewing configuration;

FIG. 3C is a perspective view of the FIG. 3A device-support apparatus in its intermediate storage configuration;

FIG. 3D a perspective view of the FIG. 3A device-support apparatus in its compact configuration;

FIG. 4A is a perspective view of a hands-free device-support apparatus according to a third embodiment of the invention in its expanded configuration;

FIG. 4B is a perspective view of the FIG. 4A device-support apparatus in its intermediate viewing configuration;

FIG. 4C is a perspective view of the FIG. 4A device-support apparatus in its intermediate storage configuration;

FIG. 4D is a perspective view of the FIG. 4A device-support apparatus in its compact configuration;

FIG. 5A is a perspective view of a hands-free device-support apparatus according to a fourth embodiment of the invention in its expanded configuration;

FIG. 5B is a perspective view of the FIG. 5A device-support apparatus in its expanded configuration on a user's body;

FIG. 5C is a perspective view of the FIG. 5A device-support apparatus in its intermediate viewing configuration;

FIG. 5D is a perspective view of the FIG. 5A device-support apparatus in its intermediate storage configuration;

FIG. 5E is a perspective view of the FIG. 5A device-support apparatus in its compact configuration;

FIG. 6 is a perspective view of a hands-free device-support apparatus according to another embodiment of the invention;

FIG. 7 is perspective view of a modified version of the FIG. 6 device-support apparatus;

FIG. 8A is a perspective view of a hands-free device-support apparatus according to yet another embodiment of the invention for use as a personal multimedia entertainment system;

FIG. 8B is a different perspective view of the FIG. 8A device-support apparatus;

FIG. 8C is a perspective view of a modified version of the FIG. 8A device-support apparatus;

FIG. 9 schematically depicts one technique for coupling a portable electronic device to a device-support member in accordance with a particular embodiment of the invention;

FIGS. 10A-10C schematically depict a different technique for coupling a portable electronic device to a device-support member in accordance with another embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the disclosure. Accordingly, the specification and drawings are to be regarded in an illustrative, rather than a restrictive, sense.

Particular embodiments of the invention provide device-support apparatus for supporting portable electronic devices in front of the body of a user. The device-support apparatus comprise arms which extend from a central chest-engaging member on the user's chest, over the user's shoulder(s), to a pair of back-engaging members on the user's back. The device-support apparatus also comprises a device-support assembly which may extend forwardly from the chest-engaging member to support a portable electronic device in front of the user's body. The arms of the device-support apparatus need not be supported by the user's shoulders. Preferably, the arms are supported, in locations spaced-apart from the user's shoulders, by forces acting between the chest-engaging member and the user's chest and by forces acting between the pair of back-engaging members and the user's back. The arms may be resiliently deformable, such that the resilient forces which tend to restore the arms to their original shapes add to the forces between the chest-engaging member and the user's chest and to the forces between the back-engaging members and the user's back to thereby help support the apparatus and to help support the device in front of the user's body.

In accordance with particular embodiments of the invention, the device-support apparatus are adjustable into multiple configurations. Preferably, the device-support apparatus are adjustable into a number of configurations while the portable electronic device is supported in front of the user's body. In particular embodiments, the device-support apparatus are adjustable between:
an expanded configuration wherein the portable electronic device is supported by a device-support assembly (or device-support member) at a location forwardly spaced-apart from the chest-engaging member, such that the user can easily view and otherwise interact with the device;
an intermediate viewing configuration wherein device-support assembly is collapsed such that the portable electronic device is supported at a location adjacent to, and possibly forwardly of, the chest-engaging member, but wherein the user can still view and otherwise interact with a principal user interface of the device; and
an intermediate storage configuration wherein the portable electronic device is supported at a location wherein its principal user interface is:
   adjacent to, and possibly forwardly of, the chest-engaging member such that the chest-engaging member provides protection to the principal user interface;
   adjacent to, and possibly forwardly of, the arms of the device-support apparatus such that the arms provide protection to the principal user interface; and/or
   adjacent to, and possibly forwardly of, the user's chest such that the user's chest provides protection to the principal user interface.
      Preferably, the device-support apparatus are removable from the user's body and, once removed, are further adjustable to a compact configuration, wherein the arms of the apparatus are collapsed or otherwise compacted to a smaller volume to facilitate storage and transport of the device and/or the apparatus. In some embodiments, when the device-support apparatus are in their compact configuration, the device-support apparatus house (at least partially) and provide protection to the portable electronic device during storage and/or transport of the device.

In particular embodiments, when the device-support apparatus is in its expanded configuration, the device is supported at a location that is forwardly spaced-apart from the chest-engaging member by a distance greater than about 12 cm. In some embodiments, this distance is greater than about 15 cm. In particular embodiments, when the device-support apparatus is in its intermediate storage configuration, the device is supported at a location that is forwardly spaced-apart from the chest-engaging member by less than about 8 cm. In some embodiments, this distance is less than about 5 cm. In particular embodiments, when the device-support apparatus is in its intermediate storage configuration, a user interface of the device is supported at a location that is forwardly spaced-apart from the chest-engaging member by less than about 2 cm. In some embodiments, this distance is less than about 1 cm. In particular embodiments, when the device-support apparatus is in its intermediate viewing configuration, a first part of the device is supported at a location spaced forwardly from the chest-engaging member by less than about 5 cm and a second part of the device is supported at a location that is spaced forwardly from the chest-engaging member by more than about 5 cm.

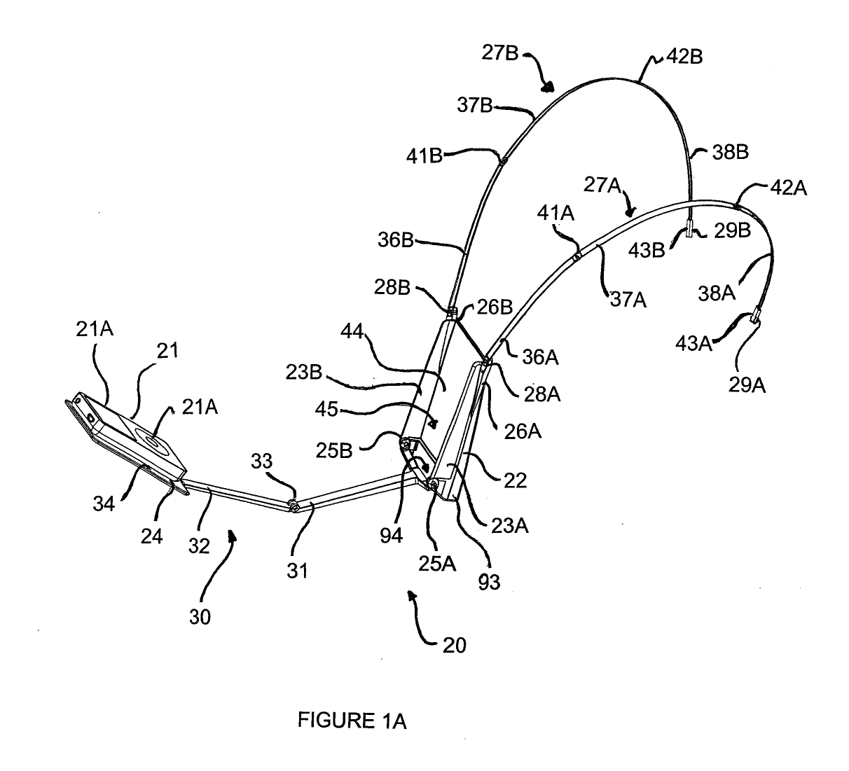

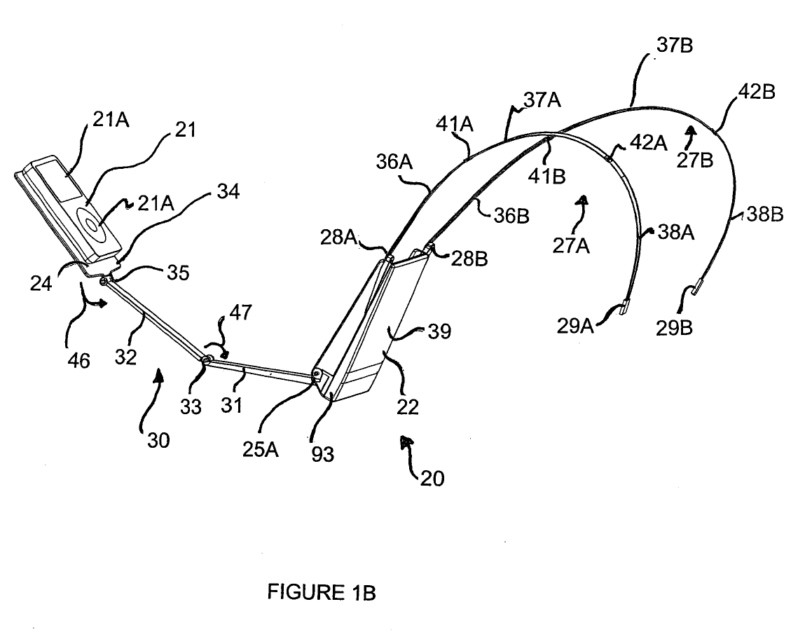

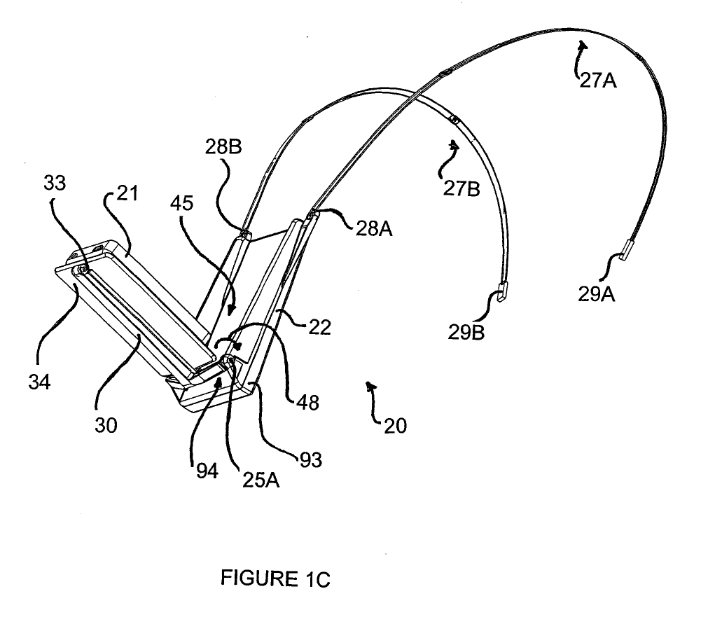

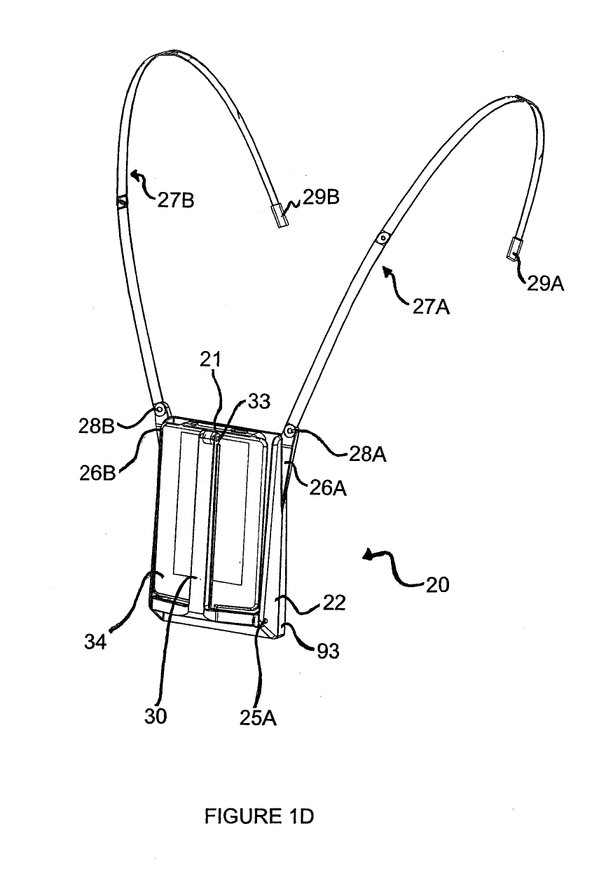

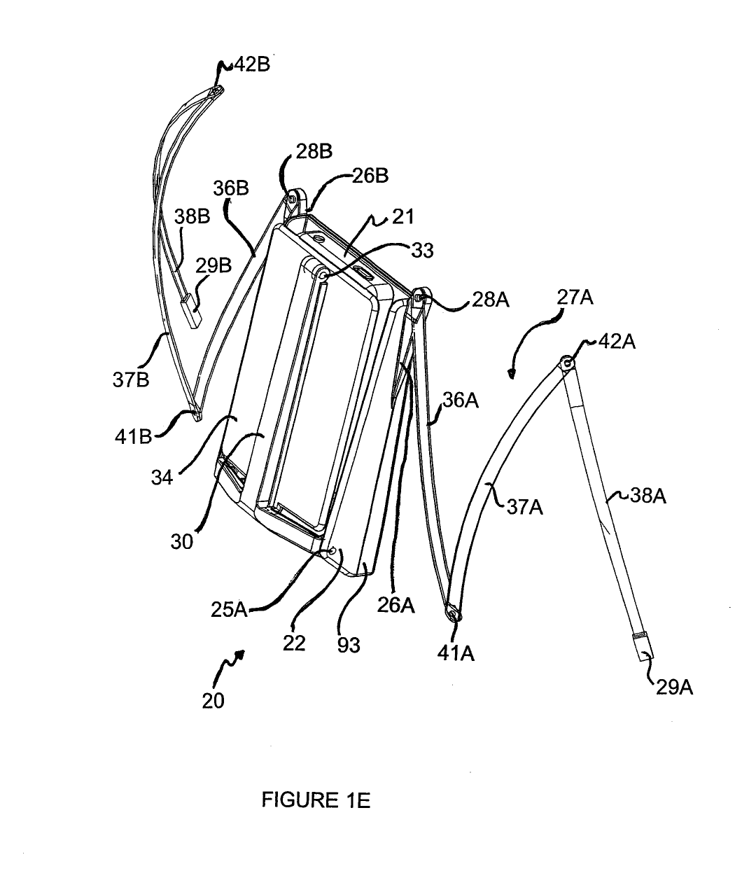

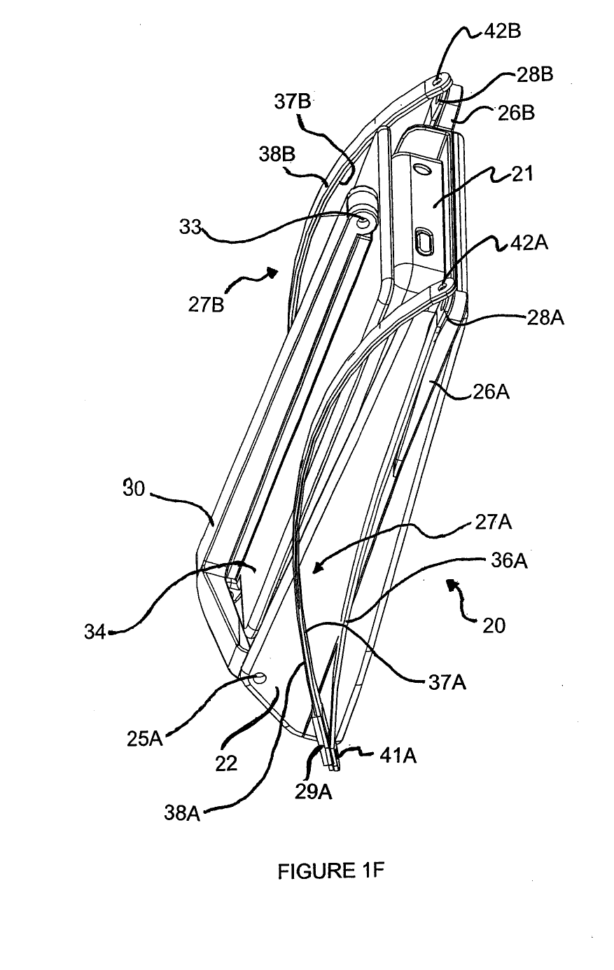

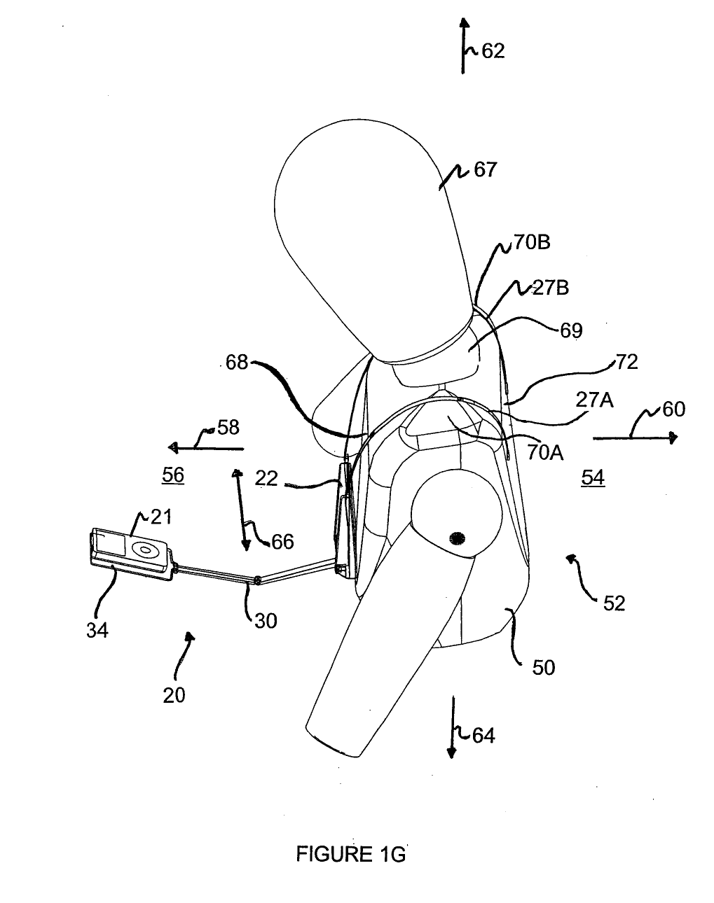

FIGS. 1A-1G depict various views of a hands-free device-support apparatus 20 according to a particular embodiment of the invention in its various configurations. Device-support apparatus 20 supports portable electronic device 21. In the illustrated embodiment, portable electronic device 21 is a media storage and playback device. However, those skilled in the art will appreciate that device-support apparatus 20 may generally be used with any portable electronic device. As shown in FIG. 1G, device-support apparatus 20 supports portable electronic device 21 in front of the body 50 of user 52, such that user 52 can view and otherwise interact with device 21.

This description and the accompanying claims use a number of directional conventions to clarify their meaning:
(i) “front”, “frontward”, “forward”, “forwardly” and “forwardmost” and similar words are used to refer to directions that are generally oriented from the back 54 of user 52 toward the front 56 of user 52 (see for example arrow 58 of FIG. 1G);
(ii) “back”, “backward”, “rear”, “rearward”, “rearwardly”, “rearwardmost” and similar words are used to refer to directions that are generally oriented from the front 56 of user 52 to the back 54 of user 52 (see for example arrow 60 of FIG. 1G);
(iii) “up”, “upwardly”, “upwardmost”, “upper” and similar words refer to directions that are generally oriented away from the ground (see arrow 62 of FIG. 1G);
(iv) “down”, “downwardly”, “downwardmost” and “lower” and similar words refer to directions that are generally oriented toward the ground (see arrow 64 of FIG. 1G);
(iii) “transverse”, “transversely”, “side”, “sideways” and similar words refer to directions that are generally orthogonal to the forward, rearward, upward and downward directions (see double-headed arrow 66 of FIG. 1G).

As shown best FIGS. 1A, 1B and 1G, device-support apparatus 20 comprises a chest-engaging member 22, a pair of arm assemblies 27A, 27B and a device-support assembly 30. FIG. 1G shows how device-support apparatus 20 is mounted on the body 50 of user 52 to support device 21. A rearward surface 39 of chest-engaging member 22 abuts against the chest 68 of user 52. Arm assemblies 27A, 27B extend from chest-engaging member 22 over the shoulders 70A, 70B of user 52. The opposing end of each arm assembly 27A, 27B (i.e. distal from chest-engaging member 22) comprises a corresponding back-engaging member 29A, 29B. Forward surfaces 43A, 43B of back-engaging members 29A, 29B abut against the back 72 of user 52. Device-support assembly 30 extends generally forwardly from chest-engaging member 22 to support device 21 in front 56 of the user's body 50.

It is not necessary that arm assemblies 27A, 27B contact shoulders 70A, 70B or that shoulders 70A, 70B support arm assemblies 27A, 27B or device-support apparatus 20. Frictional forces between rearward surface 39 of chest-engaging member 22 and the user's chest 68 preferably prevent chest-engaging member 22 from moving upwardly or downwardly relative to the user's chest 68. Similarly, frictional forces between forward surfaces 43A, 43B of back-engaging members 29A, 29B and the user's back 72 preferably prevent back-engaging members 29A, 29B from moving upwardly or downwardly relative to the user's back 72.

Arm assemblies 27A, 27B may be resiliently deformable over a relatively wide range of applied stress. Resilient deformation may involve substantially elastic deformation. Such elastic deformation allows arm assemblies 27A, 27B to bend to accommodate users having different body thicknesses (i.e. chest to back thicknesses). In some embodiments, the material(s) from which arm assemblies 27A, 27B are fabricated exhibit substantially elastic deformation up to yield strengths of over 45 MPa. In other embodiments, this yield strength is over 200 MPa. Preferably, arm assemblies 27A, 27B are at least partially deformed when device-support apparatus 20 is mounted on the body 50 of user 52. When arm assemblies 27A, 27B are deformed in this manner, the resilient forces associated with arm assemblies 27A, 27B tend to exert force against the chest 68 of user 52 (through chest-engaging member 22) and against the back 72 of user 52 (through back-engaging members 29A, 29B). These resilient forces tend to increase the friction between rearward surface 39 of chest-engaging member 22 and chest 68 and between forward surfaces 43A, 43B of back-engaging members 29A, 29B and back 72, thereby increasing the ability of device-support apparatus 20 to support device 21.

In some embodiments, the material(s) from which arm assemblies 27A, 27B are fabricated is/are relatively ductile at applied stresses greater than the yield strength. A ductile material is a material capable of withstanding applied stresses greater than its yield strength without fracture. When a material is subjected to stresses above its yield strength, the material deforms in a manner that is non-reversible. Such deformations may be referred to as “plastic deformations”. Eventually, if the applied stresses are too great, then the material will fracture, rupture or otherwise become compromised. This stress level is referred to as the “ultimate strength” of the material. In some embodiments, the material from which arm assemblies 27A, 27B are fabricated exhibits an ultimate strength that is greater than its yield strength by about 20% or more (i.e. the ratio of the ultimate strength to the yield strength is greater than about 1.2). In some embodiments, this ratio is greater than about 1.4. This ductility allows users to further adjust the front-to-back dimension of arm assemblies 27A, 27B (i.e. the spacing between chest-engaging member 22 and back-engaging members 29A, 29B) by applying a stress that is greater than the yield strength of arms assemblies 27A, 27B (but less than the ultimate strength of arm assemblies 27A, 27B), such that when the stress is removed and arm assemblies 27A, 27B spring back, they have a different front-to-back dimension.

In the illustrated embodiment, a rearward portion of chest-engaging member 22 comprises a deformable pad 93. Pad 93 may comprise (or may be coated with) material(s) having a relatively high coefficient of friction. Suitable materials are known to those skilled in the art and include, without limitation, various types of silicone, various types of urethane, various types of thermoplastic elastomers or the like. Pad 93 is preferably deformable to increase user comfort level at the same time as increasing the friction between rearward surface 39 of chest-engaging member 22 and the user's chest 68. In the illustrated embodiment, pad 93 is thinner at its upper end and thicker at its downward end. This shape may allow portion(s) of rearward surface 39 to be separated from the user's chest 68 when device-support apparatus 20 is in certain configurations. Back-engaging members 29A, 29B may comprise similar pads (not specifically enumerated) to increase the friction and/or comfort level between forward surfaces 43A, 43B of back-engaging members 29A, 29B and the user's back 72. In alternative embodiments, pad 93 is not required and rearward surface 39 of chest-engaging member 22 may be coated with a high-friction material. In currently preferred embodiments, the coefficients of friction of rearward surface 39 and forward surfaces 43A, 43B is 0.5 or greater.

Device-support apparatus 20 is adjustable into a number of different configurations. FIGS. 1A, 1B and 1G show device-support apparatus 20 in its expanded configuration. In its expanded configuration, device-support assembly 30 supports device 21 at a location that is forwardly spaced-apart from chest-engaging member 22 and from the user's chest 68. When device-support apparatus 20 is in its expanded configuration, user 50 can comfortably view and otherwise interact with device 21. By way of non-limiting examples, user 50 may watch video media being played back on device 21 or may input an email message onto device 21 using their hands. When device-support apparatus 20 is in its expanded configuration, people other than user 50 may also be able to see and/or interact with device 21.

FIG. 1C depicts device-support apparatus 20 in its intermediate viewing configuration wherein device-support assembly 30 is collapsed such that it supports device 21 at a location adjacent to chest-engaging member 22 and user's chest 68. When device-support apparatus 20 is in its intermediate viewing configuration, user 50 can still view and otherwise interact with principal user interface 21A of device 21. In some circumstances, the intermediate viewing configuration of device-support apparatus 20 is advantageous, such as where user 52 is interacting with device 21 in a environment having limited space (e.g. on a bus or in a crowd), where user 52 would prefer increased privacy (e.g. when reading or writing confidential emails) or where user 52 wants to take a quick glance at device 21 but is not interested in viewing device 21 for a long period of time, for example.

FIG. 1D depicts device-support apparatus 20 in its intermediate storage configuration wherein device 21 is supported at a location such that principal user interface 21A is adjacent chest-engaging member 22. When device-support apparatus 20 is in its intermediate storage configuration, chest-engaging member 22 may provide protection to principal user interface 21A (i.e. device 21 is stored such that its principal user interface 21A is protectively stowed against a forward surface 44 of chest-engaging member 22). The intermediate storage configuration of device-support apparatus 20 is convenient in circumstances where user 52 may not want to actively view or interact with principal user interface 21A of device 21 or may not want to take device-support apparatus 20 off of their body 50.

By way of non-limiting example, user 52 may not be actively emailing someone and therefore may not need to actively interact with device 21, but may be expecting an important email in the near future, so user 52 may not want to take device-support apparatus 20 off of their body 50. The intermediate storage configuration may also be useful where device 21 comprises an audio playback capability and the user is interested in listening to device 21, but does not have to view principal user interface 21A. This is particularly useful where user 52 is engaged in vigorous activity, such as jogging for example, because the force of gravity acting on device 21 causes less torque when device-support apparatus 20 is in its intermediate storage configuration. The intermediate storage configuration is also advantageous where device-support apparatus 20 is mounted to the body 50 of user 52 underneath a coat, a sweater or the like. In such circumstances, the intermediate storage configuration provides a convenient way for user 52 to transport device 21 under their coat without removing their coat or removing device-support apparatus 20 from their body 50. In general, user 52 may use device-support assembly 20 in its intermediate storage configuration to carry device 21 in a wide variety of circumstances, rather than carrying device 21 on a belt clip, in a separate bag, in a pocket or the like.

Once device-support apparatus 20 is removed from the body 50 of user 52, it can be adjusted to its compact configuration shown in FIG. 1F. As explained in more detail below, adjusting device-support apparatus 20 to its compact configuration involves collapsing arm assemblies 27A, 27B and device-support assembly 30 toward chest-engaging member 22. The compact configuration of device-support apparatus 20 is convenient for storing and/or transporting device-support apparatus 20. In the illustrated embodiment, device-support apparatus 20 is also capable of at least partially housing device 21 when device-support apparatus 20 is in its compact configuration and thereby protects device 21 during transport and/or storage. In some embodiments, device-support apparatus 20 may be provided with a case, pouch or the like, in which device-support apparatus 20 and device 21 may be stored when device-support apparatus 20 is in its compact configuration.

In the illustrated embodiment, device-support apparatus 20 comprises flanges 23A, 23B which project forwardly from the sides of chest-engaging member 22 to form a generally U-shaped cradle 45 between flange 23A, the forward surface 44 of chest-engaging member 22 and flange 23B. Device 21 may be located in cradle 45 when device-support apparatus 20 is adjusted to its intermediate storage configuration (FIG. 1D) and when device-support apparatus 20 is adjusted to its compact configuration (FIG. 1F).

In the illustrated embodiment, device-support assembly 30 comprises an elongated first segment 31, an elongated second segment 32 and a device-mounting member 34. A first end of first segment 31 is pivotally coupled to flanges 23A, 23B via pivot joints 25A, 25B and the opposing end of first segment 31 is pivotally coupled to second segment 32 via pivot joint 33. The opposing end of second segment 32 is in turn pivotally coupled to device-mounting member 34 via pivot joint 35. In the illustrated embodiment (as shown best in FIG. 1D), first and second segments 31, 32 each have a length that is approximately equal to that of device 21. In other embodiments, first and second segments 31, 32 may be longer (e.g. to provide more range to extend device 21 forwardly away from the user's chest 68) or shorter (e.g. to minimize the toque caused by gravity acting on device 21 and to thereby provide increased stability).

As shown best in FIG. 1A, the coupling between first segment 31 and flanges 23A, 23B at pivot joints 25A, 25B may define an aperture 94 at the bottom of chest-engaging member 22 (e.g. between first segment 31, flanges 23A, 23B and forward surface 44 of chest-engaging member 22). Preferably, the presence of aperture 94 is independent of the configuration of device-support apparatus 20. The bottom sides of many portable electronic devices have I/O ports for connecting to other devices (e.g. computers, headphones, other portable devices or the like). Cables or other devices for connecting to such I/O ports may extend through aperture 94. Some portable electronic devices have user interface components (e.g. power switches or the like) located on their bottom sides and user 52 may access such user interface components through aperture 94. In some embodiments, flanges 23A, 23B may be foldable or detachable from chest-engaging member 22 to provide similar access to I/O ports and/or user interface components on the sides of device 21.

User 52 may adjust one or more of pivot joints 25A, 25B, 33, 35 to adjust the relative position and/or orientation of device 21 when device-support apparatus 20 is in its expanded configuration and when device-support apparatus 20 is in its intermediate viewing configuration. Adjustment of pivot joints 25A, 25B, 33, 35 allows user 52 to optimize the position and/or orientation of device 21 for viewing or otherwise interacting with device 21. By way of non-limiting example, user 52 may want to change the relative orientation of pivot joint 35 depending on whether user 52 is standing or sitting down or user 52 may want to adjust pivot joint 33 to move device 21 closer to his or her body 50 when inputting information into device 21 and further from his or her body 50 when viewing device 21. In some embodiments, pivot joints 25A, 25B, 33, 35 are adjustable such that device 21 is positionable at a location approximately 30-60 cm from the eyes of user 52.

Preferably pivot joints 25A, 25B, 33, 35 are relatively high friction pivot joints or are otherwise capable of preventing the components of device-support assembly 30 (i.e. first segment 31, second segment 32 and device-mounting member 34) from moving relative to flanges 23A, 23B or relative to one another, unless pivot joints 25A, 25B, 33, 35 are subjected torques greater than might be caused by gravity and other non-intentional external forces (e.g. forces which may arise due to user movements, such as walking or jogging) which may act on device 21 and/or device-support apparatus 20. When pivot joints 25A, 25B, 33, 35 have this characteristic, a user must exert force to move the components of device-support assembly 30 relative to one another and/or relative to flanges 23A, 23B. This prevents undesirable movement of device 21, which may be caused by corresponding movement of pivot joints 25A, 25B, 33, 35, when user 52 is trying to view or otherwise interact with device 21.

In general, gravity and other non-intentional external forces acting on device 21 and/or apparatus 20 causes torques which act on pivot joints 25A, 25B, 33, 35. The amounts of these torques depend on the orientation of pivot joints 25A, 25B, 33, 35, the mass of device 21 and the mass of the components of device-support assembly 30. In some embodiments, the friction of pivot joints 25A, 25B, 33 and 35 is selected to be about 20% or more greater than the expected maximum torque due to gravity on a device having a known weight. In some embodiments, pivot joints 25A, 25B will not move unless subjected to torques greater than about 120 inch·oz (i.e. ˜0.85 N·m). In some embodiments, pivot joints 33, 35 will not move unless subjected to torques greater than 60 inch·oz (i.e. ˜0.42 N·m). In addition to, or as an alternative to, being high friction pivot joints, pivot joints 25A, 25B, 33, 35 may comprise pivot joint locking mechanisms (e.g. thumbscrews or the like), which allow the pivot joint to be locked in particular angular orientations. In particular embodiments, the locking mechanisms of pivot joints 25A, 25B, 33, 35 comprise “click stops” which allow pivot joints 25A, 25B, 33, 35 to lock at particular discrete angular orientations.

One or more of pivot joints 25A, 25B, 33, 35 may comprise physical stops (not shown) which limit the range of motion of the pivot joint. For example, pivot joints 25A, 25B may comprise physical stops which limit the range of motion of first segment 31 to approximately 90°-120° relative to flanges 23A, 23B (e.g. from an orientation where first segment 31 extends generally upwardly from pivot joints 25A, 25B (see the compact configuration of FIG. 1D) to an orientation where first segment 31 extends generally forwardly from pivot joints 25A, 25B (see the expanded configuration of FIGS. 1A, 1B)). Other pivot joints 33, 35 may comprise similar physical stops.

In the illustrated embodiment, device-mounting member 34 comprises a generally-planar surface 24 to which device 21 is releasably mounted. Device 21 may generally be mounted to device-mounting member 34 using any suitable technique. For some types of devices, device 21 is mountable to device-mounting member 34 in at least two orientations or mounting member 34 is adjustable to at least two orientations. For example, device 21 may be mountable to a device-mounting member 34 in a “portrait” orientation, wherein the elongated dimension of device 21 has a particular direction, and a “landscape” orientation, wherein the elongated dimension of device 21 has an orthogonal direction. Additionally or alternatively, device mounting member 34 may adjustable such that device 21 has a portrait or landscape orientation.

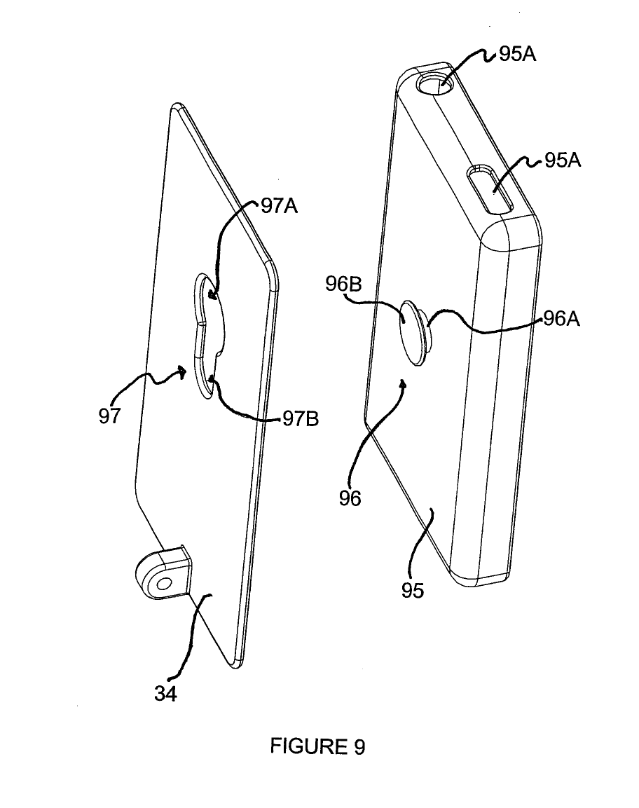

FIG. 9 schematically depicts a particular embodiment for coupling device 21 to device-mounting member 34. In the illustrated embodiment, device 21 is inserted into a flexible sleeve 95, which may be made of plastic or the like. Preferably, sleeve 95 is sufficiently flexible to permit user 52 to interact with device 21 through the body of sleeve 95. Sleeve 95 may have one or more apertures 95A which allow access to corresponding I/O ports (not shown) or to corresponding user interface components (not shown) on device 21. Sleeve 95 may comprise a transparent section and/or an apertures corresponding to principal user interface 21A of device 21.

Sleeve 95 comprises fastener component 96. In some embodiments, fastener component 96 is coupled to sleeve 95 using suitable fastener(s) or adhesive, for example. In the illustrated embodiment, fastener component 96 is a male fastener component having a shaft 96A and a head 96B. The dimensions of head 96B are larger than those of shaft 96A. Device-mounting member 34 comprises a corresponding female fastener component 97, which has a wider-dimensioned region 97A and a narrower-dimensioned region 97B. In operation, the head 96B of male fastener component 96 is inserted through the wider-dimensioned region 97A of female fastener component 97 and then the shaft 96A of male fastener component 96 is slid down into narrower-dimensioned region 97B of female fastener component 97. Sleeve 95 (and device 21) are then coupled to device-mounting component 34 by the interaction between female fastener components 97 and male fastener component 96.

Preferably, the friction between female fastener components 97 and male fastener component 96 is such that user 52 may twist shaft 96A within narrower-dimensioned region 97B and may thereby pivot device 21 to its “portrait” and “landscape” orientations (or to any other desirable orientation). In some embodiments, the positions of male and female fastener components 96, 97 are reversed. In some embodiments, sleeve 95 is not required and fastener component 96 may be a part of device 21 (or may be coupled to device 21).

Other techniques may also be used to mount device 21 to device-mounting member 34. By way of non-limiting example, fasteners (e.g. hook and loop fasteners or clip-type fasteners) having adhesive on one of their sides may be adhered to each of device-mounting member 34 and sleeve 95 (or device 21) to permit sleeve 95 (and/or device 21) to be releasably mounted to device-mounting member 34. In other embodiments, sleeve 95 (or device 21) may be provided with loops or hooks similar to belt mounting hooks or loops and device-mounting member 34 may comprise a horizontal band similar to a belt to engage the hooks and/or loops. In still other embodiments, device-mounting member 34 may comprise deformable flanges or the like that are shaped to form a “snap-together” coupling capable of receiving device 21. In such embodiments, device-mounting member 34 may be particular to a device 21 having certain dimensions. Those skilled in the art will appreciate that there are still other suitable techniques for coupling device 21 to device-support member 34 and that the invention should be understood to include any suitable technique.

In the illustrated embodiment, adjustment of device-support apparatus 20 between its expanded configuration and its intermediate viewing configuration involves: (i) pivoting device-mounting member 34 relative to second segment 32 about pivot joint 35 in the direction indicated by arrow 46 (FIG. 1B); and (ii) pivoting second segment 32 relative to first segment 31 about pivot joint 33 in the direction indicated by arrow 47 (FIG. 1B). Adjustment of device-support apparatus 20 between its intermediate viewing configuration and its intermediate storage configuration involves pivoting first segment 31 relative to flanges 23A, 23B about pivot joints 25A, 25B in the direction indicated by arrow 48 (FIG. 1C).

When device-support apparatus 20 is in its intermediate storage configuration, device 21 is protectively housed in cradle 45 (i.e. between chest-engaging member 22, flanges 23A, 23B and device-mounting member 34). In some embodiments, cradle 45 comprises a lower flange and/or an upper flange to form a complete enclosure around device 21 when device 21 is in its intermediate storage configuration. Adjusting device-support apparatus 20 between its intermediate storage configuration, through its intermediate viewing configuration and into its expanded configuration involves pivoting pivot joints 25A, 25B, 33, 35 in the opposite directions. In some embodiments, device-support apparatus 20 may comprise a user-adjustable clasp, pawl or the like (e.g. on one or both of flanges 23A, 23B) which locks pivot joints 25A, 25B, thereby preventing device-support apparatus 20 from moving between its intermediate storage configuration and its intermediate viewing configuration. In other embodiments, friction in pivot joints 25A, 25B prevents device-support apparatus 20 from moving between its intermediate storage configuration and its intermediate viewing configuration.

In the illustrated embodiment, device-support apparatus 20 comprises fingers 26A, 26B which project transversely and upwardly from the sides of chest-engaging member 22. Arm assemblies 27A, 27B are connected to fingers 26A, 26B via pivot joints 28A, 28B. Arm assemblies 27A, 27B respectively comprise first segments 36A, 36B pivotally connected to second segments 37A, 37B by pivot joints 41A, 41B, third segments 38A, 38B pivotally connected to the opposing ends of second segments 37A, 37B by pivot joints 42A, 42B and back-engaging members 29A, 29B located at the opposing ends of third segments 38A, 38B. In the illustrated embodiment, first segments 36A, 36B have a slight curvature while second and third segments 37A, 37B, 38A, 38B have more pronounced and substantially similar curvatures. This shaping of first, second and third segments 36A, 36B, 37A, 37B, 38A, 38B is not necessary.

User 52 may adjust one or more of pivot joints 28A, 28B, 41A, 41B, 42A, 42B to adjust the relative position and/or orientation of arm assemblies 27A, 27B and back-engaging members 29A, 29B. Adjustment of pivot joints 28A, 28B, 41A, 41B, 42A, 42B allows user 52 to optimize the position and/or orientation of back-engaging members to provide maximum support for device 21 while providing maximum comfort for user 52. By way of non-limiting example, user 52 may have shoulders that are particularly thick (i.e. from front to back) and may therefore opt to adjust pivot joints 28A, 28B, 41A, 41B, 42A, 42B such that arm assemblies 27A, 27B are as straight as possible providing the maximum front to back extension.

As with the pivot joints discussed above, pivot joints 28A, 28B, 41A, 41B, 42A, 42B are preferably capable of preventing undesired relative movement of the components of arm assemblies 27A, 27B relative to one another or relative to chest-engaging member 22 unless pivot joints 28A, 28B, 41A, 41B, 42A, 42B are subjected torques greater than might be exerted by the force of gravity on device 21 and/or device-support apparatus 20. Pivot joints having this characteristics allow movement by user 52 but prevent undesirable movement of device 21, which may be caused by corresponding movement of pivot joints 28A, 28B, 41A, 41B, 42A, 42B, when user 52 is trying to view or otherwise interact with device 21. In some embodiments, pivot joints 28A, 28B, 41A, 41B, 42A, 42B will not move unless subjected to torques greater than 20 inch·oz (i.e. ˜0.14 N·m). In some embodiments, pivot joints 28A, 28B, 41A, 41B, 42A, 42B will not move unless subjected to torques greater than 40 inch·oz (i.e. ˜0.28 N·m). Pivot joints 28A, 28B, 41A, 41B, 42A, 42B may comprise or otherwise make use of any suitable construction, including those discussed above (see discussion of joints 25A, 25B, 33, 35) for preventing undesirable movement except in circumstances where such movement is initiated by user 52.

Adjustment of device-supporting apparatus 20 between its intermediate storage configuration and its compact configuration involves removing device-support apparatus 20 from the body 50 of user 52 and collapsing arm assemblies 27A, 27B. Device-support apparatus 20 may be removed from the body 50 of user 52 by deforming arm assemblies 27A, 27B and lifting device-support assembly 20 upwardly and away from the shoulders 70A, 70B of user 52. FIG. 1E shows arm assemblies 27A, 27B in a partially collapsed state. In the illustrated embodiment, collapsing arm assemblies 27A, 27B involves: (i) pivoting first segments 36A, 36B about pivot joints 28A, 28B until first segments 36A, 36B extend generally along the sides of chest-engaging member 22; and (ii) pivoting second and third segments 37A, 37B, 38A, 38B about pivot joints 41A, 41B, 42A, 42B until second and third segments 37A, 37B, 38A, 38B are generally parallel with first segments 36A, 36B. Collapsing arm assemblies 27A, 27B can be done in any order. Adjusting device-support apparatus 20 from its compact configuration to its intermediate storage configuration involves reversing the above-discussed adjustment.

In general, device-support apparatus 20 may be fabricated from any suitable materials. In currently preferred embodiments, chest-engaging member 22, device-support assembly 30 and back-engaging members 29A, 29B are fabricated from suitable plastic which may be rigid or resiliently deformable. Arm assemblies 27A, 27B are preferably resiliently deformable as discussed above. In some embodiments, arm assemblies 27A, 27B are fabricated from aluminum, titanium, stainless steel, some other suitable alloy, suitable plastic, carbon fiber or the like.

When device-support apparatus 20 is mounted on a user's body 50, gravity acts on device-support apparatus 20 and on device 21. The downward force caused by gravity is counteracted by: friction between chest-engaging member 22 and the user's chest 68; friction between back-engaging members 29A, 29B and the user's back 72; and resilient force associated with the deformation of arm assemblies 27A, 27B, which tends to increase the frictional forces. Preferably, these forces reach an equilibrium before arm assemblies 27A, 27B contact the user's shoulders 70A, 70B.

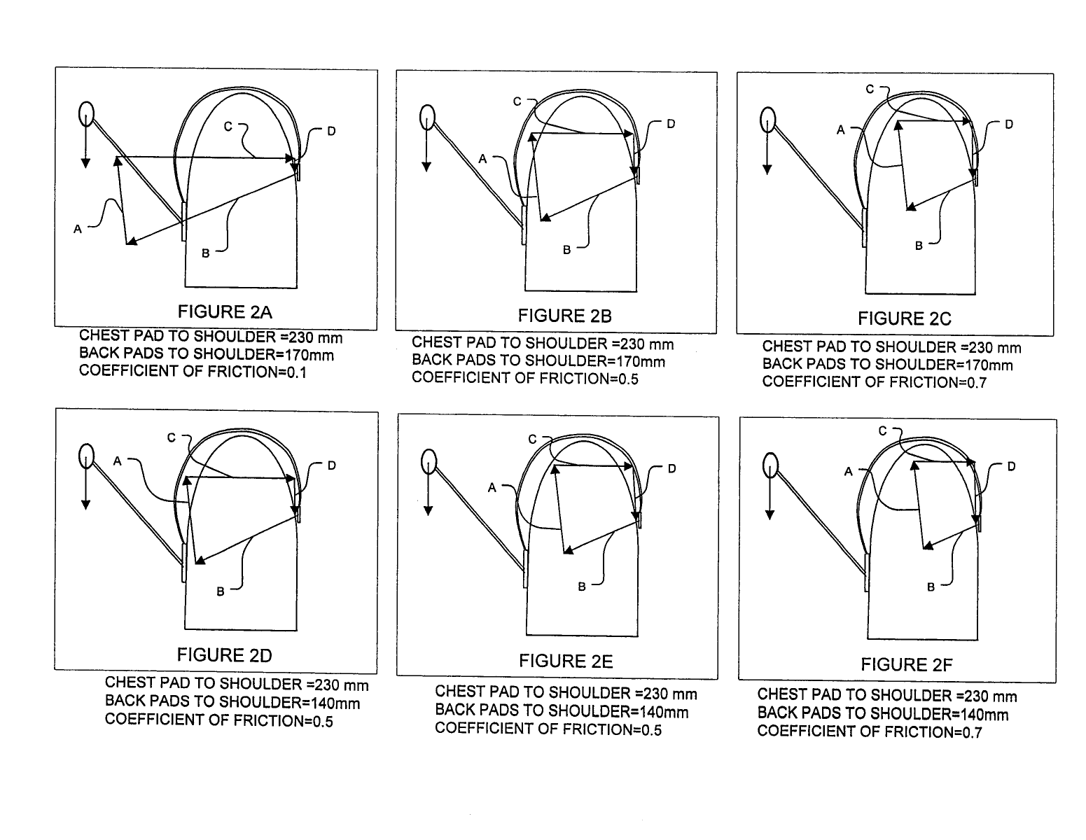

When these forces reach equilibrium, chest-engaging member 22 will not move further downwardly. However, when device-support apparatus 20 is in its expanded configuration, the force of gravity acting on device 21 can cause torque which may tend to pivot device-support apparatus 20 about chest-engaging member 22. To provide stable support for device 21, this torque is counteracted by the friction between back-engaging members 29A, 29B and the user's back 72 and by the resilient force associated with the deformation of arm assemblies 27A, 27B which tends to increase the frictional force. FIGS. 2A-2F are schematic diagrams showing vector representations of the forces that act in the vertical plane at the point where back-engaging members 29A, 29B contact the user's back 72. These forces include:
a force vector (A) created by gravity acting on device 21 and the corresponding torque on device-support apparatus 20 about chest-engaging member 22;
a force vector (B) created by the resilient restorative force of arm assemblies 27A, 27B which tends to act in a direction between back-engaging members 29A, 29B and chest-engaging member 22;
a reaction force (C) applied by the user's back 72 to back-engaging members 29A, 29B which is normal to the surface of the user's back 72; and
a force vector (D) due to friction between back-engaging members 29A, 29B and the user's back 72 which is tangential to the surface of the user's back 72.

In the schematic depiction of FIGS. 2A-2C, chest-engaging member 22 is 230 mm below the user's shoulders 70A, 70B and back-engaging members 29A, 29B are 170 mm below the user's shoulders 70A, 70B. FIGS. 2A, 2B, 2C show force vectors (A, B, C, D) which achieve equilibrium (i.e. no net torque about chest-engaging member 22) when the coefficients of friction of forward surfaces 43A, 43B of back-engaging members 29A, 29B are 0.1, 0.5, and 0.7 respectively. It can be seen from FIGS. 2A-2C, that less resilient force (B) from arm assemblies 27A, 27B is required when the coefficient of friction is higher. This may be incorporated into the design of device-support apparatus 20 (for example, by providing forward surfaces 43A, 43B of back-engaging members 29A, 29B with high friction materials) to increase user comfort and/or to allow arm assemblies 27A, 27B to be fabricated from less expensive materials.

In FIGS. 2D-2F, chest-engaging member 22 remains 230 mm below the user's shoulders 70A, 70B, but back-engaging members 29A, 29B are located further up the user's back 72 at 140 mm below the user's shoulders 70A, 70B. FIGS. 2D, 2E, 2F show force vectors (A, B, C, D) which achieve equilibrium when the coefficients of friction of forward surfaces 43A, 43B of back-engaging members 29A, 29B are 0.1, 0.5, and 0.7 respectively. FIGS. 2D-2F demonstrate that less resilient force (B) from arm assemblies 27A, 27B is required when back-engaging members 29A, 29B are located further up the user's back 72 (i.e. relative to the location of chest-engaging member 22 on the user's chest 68), provided that back-engaging members 29A, 29B are still below the region where the user's back 72 starts to slope forwardly towards shoulders 70A, 70B. These considerations may be incorporated into the design of device-support apparatus 20 (for example, by making third segments 38A, 38B of arm assemblies 27A, 27B relative short when compared to first and/or second segments 36A, 36B, 37A, 37B), to increase user comfort.

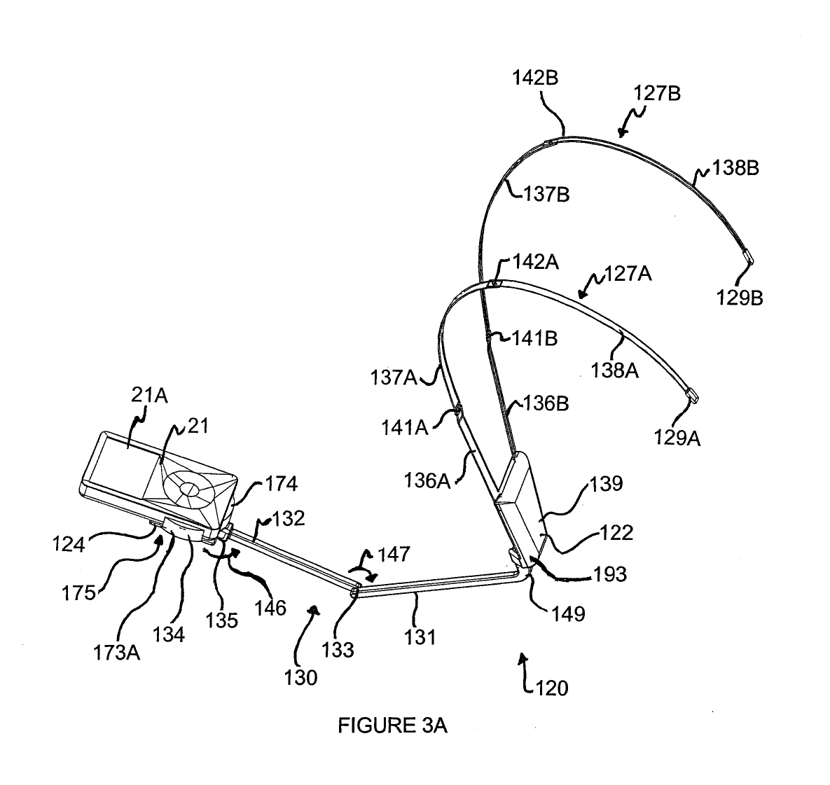

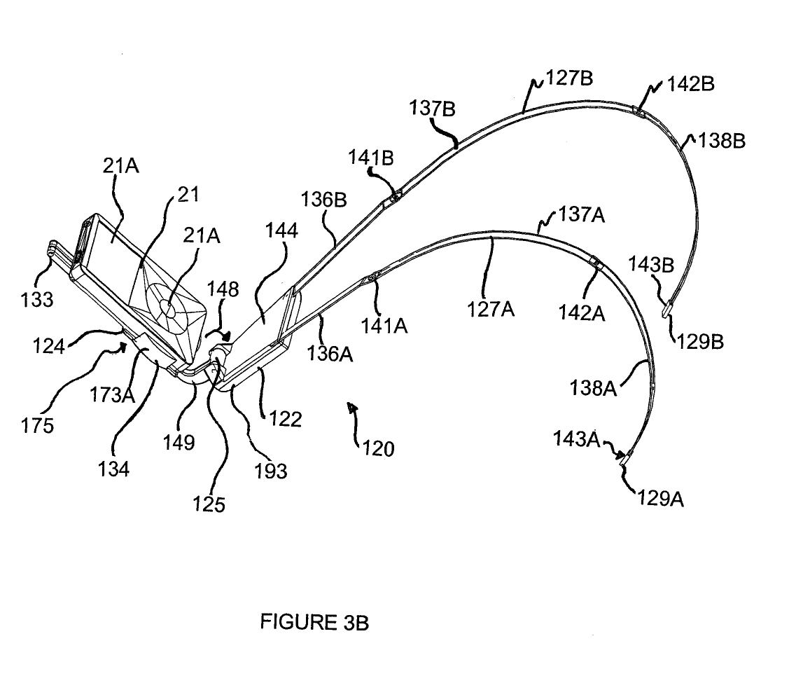

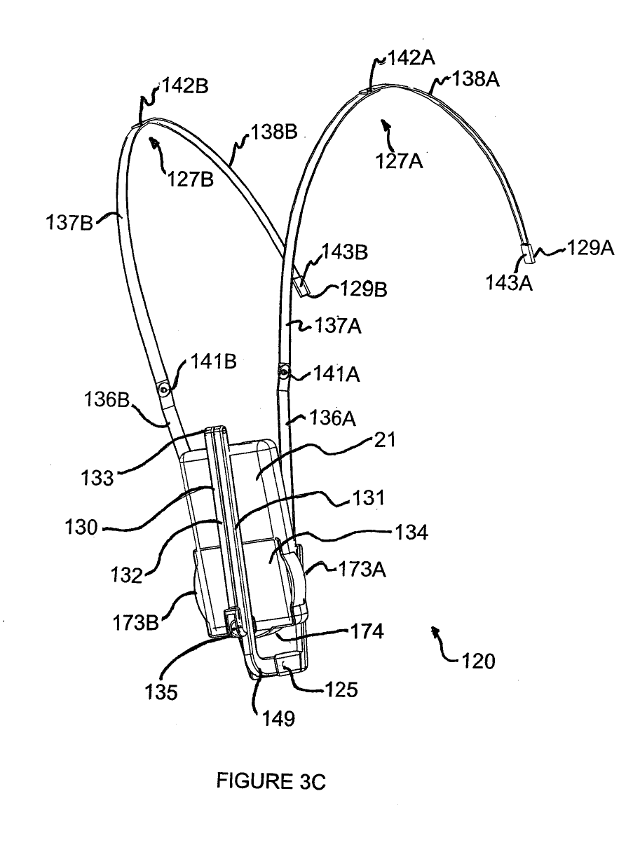

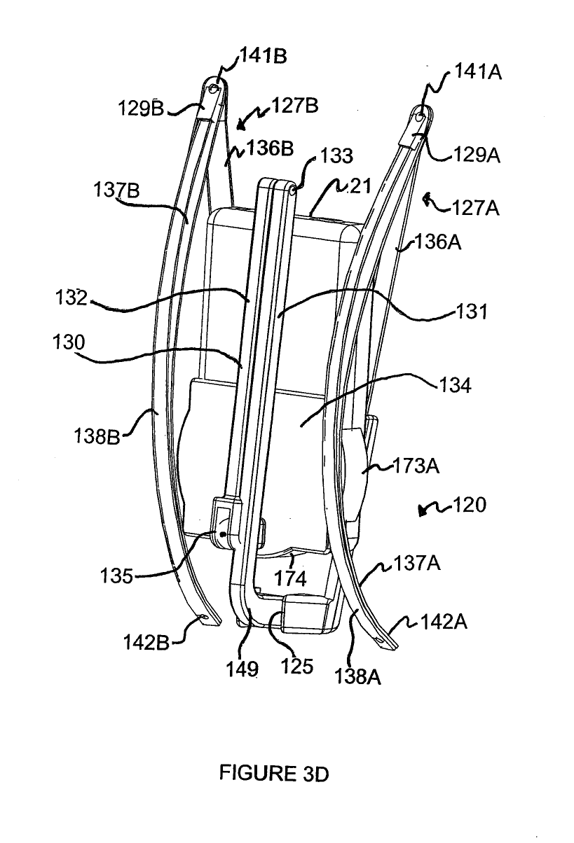

FIGS. 3A-3D show a device-support apparatus 120 according to a second embodiment of the invention in its various configurations. In many respects, device-support apparatus 120 is similar to device-support apparatus 20 discussed above. Features of device-support apparatus 120 that are similar to those of device-support apparatus 20 are accorded similar reference numerals, except that the features of device-support apparatus 120 are preceded by the numeral “1”. Like device-support apparatus 20, device-support apparatus 120 may be adjusted between an expanded configuration (FIG. 3A), an intermediate viewing configuration (FIG. 3B), an intermediate storage configuration (FIG. 3C) and a compact configuration (FIG. 3D). The functionality of each of these configurations is similar in many respects to the corresponding configurations of device-support apparatus 20.

Chest-engaging member 122, device-support assembly 130 and device-mounting member 134 of device-support apparatus 120 differ in some respects from chest-engaging member 22, device-support assembly 30 and device-mounting member 34 of device-support apparatus 20. Chest-engaging member 122 provides a rearward surface 139 for engaging the chest 68 of a user 50. Chest-engaging member 122 does not incorporate a cradle for housing device 21. Instead, as shown in FIG. 3D, when device-support apparatus 120 is adjusted to its compact configuration, device 21 is located between arm assemblies 127A, 127B, chest-engaging member 122 and device-support assembly 130. Since chest-engaging member 122 does not have a cradle, it may be possible to make chest-engaging member 122 smaller and/or more ergonomic than chest-engaging member 22.

For device-support apparatus 120, the pivot joints which couple arm assemblies 127A, 127B to chest-engaging member 122 are located between pad 193 and forward surface 144 of chest-engaging member 122 and therefore cannot be seen in the illustrated views. These pivot joints allow limited pivotal movement of arm assemblies 127A, 127B relative to chest-engaging member 122 about axes that are generally forwardly oriented. The body of chest-engaging member 122 and/or pad 193 provides physical stops which limit the range of movement of these pivot joints. These pivot joints are not necessary. In other embodiments, first segments 136A, 136B of arm assemblies 127A, 127B are integrally formed with or otherwise rigidly connected to chest-engaging member 122. Pivot joint 125 which pivotally couples chest-engaging member 122 to device-support assembly 130 is also different from pivot joints 25A, 25B provided on flanges 23A, 23B.

Device-support assembly 130 comprises first segment 131 pivotally coupled to chest-engaging member 122 via pivot joint 125 at one of its ends and pivotally coupled to second segment 132 via pivot joint 133 at its opposing end. First segment 131 differs from first segment 31 in that first segment 131 has a sharp bend 149 adjacent to pivot joint 125. In some embodiments, bend 149 is approximately 90° (e.g. between 85°-95°). As shown in FIGS. 3B, 3C and 3D, bend 149 allows first segment 131 to extend along, and provide protection to, multiple sides of device 21 when device-support apparatus 120 is in its intermediate viewing, intermediate storage and compact configurations.

Second segment 132 of device-support assembly is pivotally connected to device-mounting member 134 at pivot joint 135. Device-mounting member 134 differs from device-mounting member 34 in that device-mounting member 134 incorporates flanges 173A, 173B that project from the sides of generally planar surface 124 and flange 174 which projects from surface 124 and which extends in a direction from flange 173A toward flange 173B. Together, flanges 173A, 173B, 174 and surface 124 provide a cradle 175 in which device 21 may be mounted. Flanges 173A, 173B, 174 may be resilient and may incorporate lips, ridges, clasps or the like (not shown) which facilitate “snap-in” mounting of device 21. Cradle 175 provides some protection to device 21 from physical contact. Device 21 may be housed in a sleeve (not shown) prior to being mounted in cradle 175. In the illustrated embodiment, device-mounting member 134 extends only partially along the length of device 21. This is not necessary. In some embodiments, device-mounting member 134 extends all of the way (or more) along the length of device 21.

The use of device-support apparatus 120 is similar in many respects to that of device-support apparatus 20. Adjustment of device-support apparatus 120 between its expanded configuration (FIG. 3A) and its intermediate viewing configuration (FIG. 3B) involves: (i) pivoting device-mounting member 134 relative to second segment 132 about pivot joint 135 in the direction indicated by arrow 146; and (ii) pivoting second segment 132 relative to first segment 131 about pivot joint 133 in the direction indicated by arrow 147. Adjustment of device-support apparatus 120 between its intermediate viewing configuration (FIG. 3B) and its intermediate storage configuration (FIG. 3C) involves pivoting first segment 131 about pivot joint 125 in the direction indicated by arrow 148.

After removing device-support apparatus 120 from the body 50 of user 52, adjustment of device-support apparatus 120 between its intermediate storage configuration (FIG. 3C) and its compact configuration (FIG. 3D) involves collapsing arm assemblies 127A, 127B by pivoting second and third segments 137A, 137B, 138A, 138B about pivot joints 141A, 141B, 142A, 142B until second and third segments 137A, 137B, 138A, 138B are generally parallel with first segments 136A, 136B. As shown in FIG. 3D, second and third segments 137A, 137B, 138A, 138B of arm assemblies 127A, 127B may be longer than first segments 136A, 136B, such that in the collapsed state, the length of second and third segments 137A, 137B, 138A, 138B is similar to the combined lengths of chest-engaging member 122 and first segments 136A, 136B.

Adjusting device-support apparatus 120 between its compact configuration, through its intermediate storage configuration, through its intermediate viewing configuration and to its expanded configuration involves substantially the reverse procedure.

In other respects, device-support apparatus 120 may be similar to device-support apparatus 20.

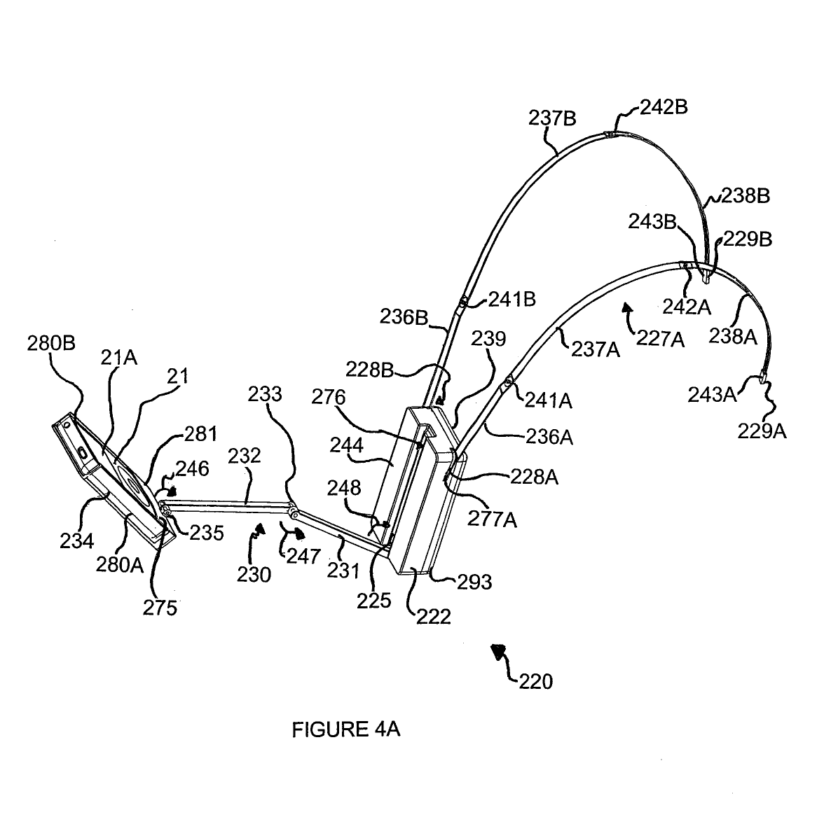

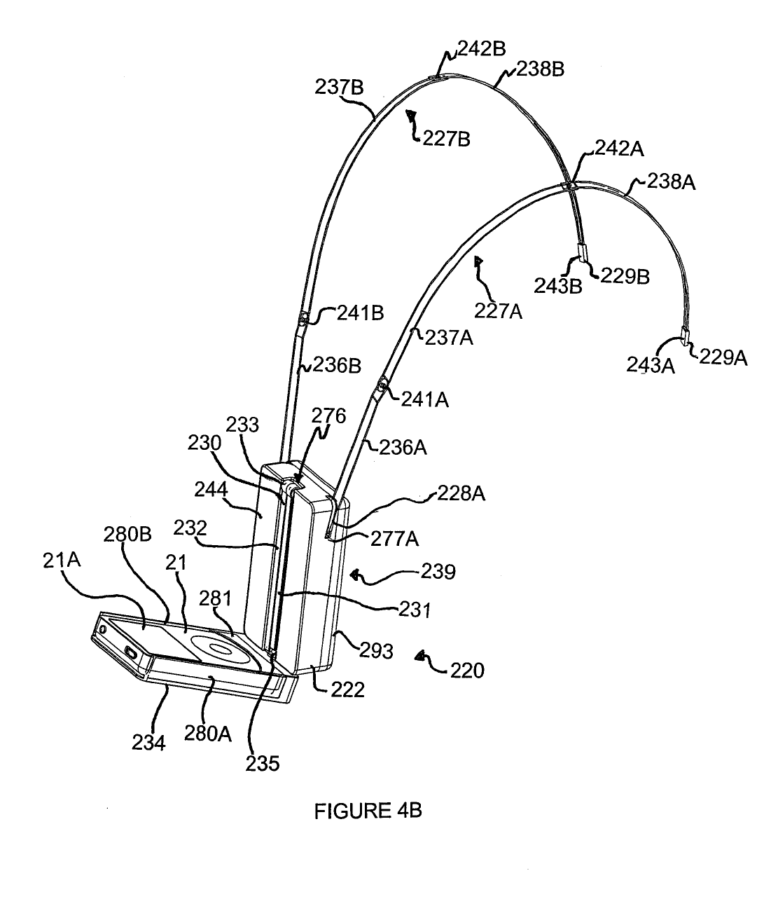

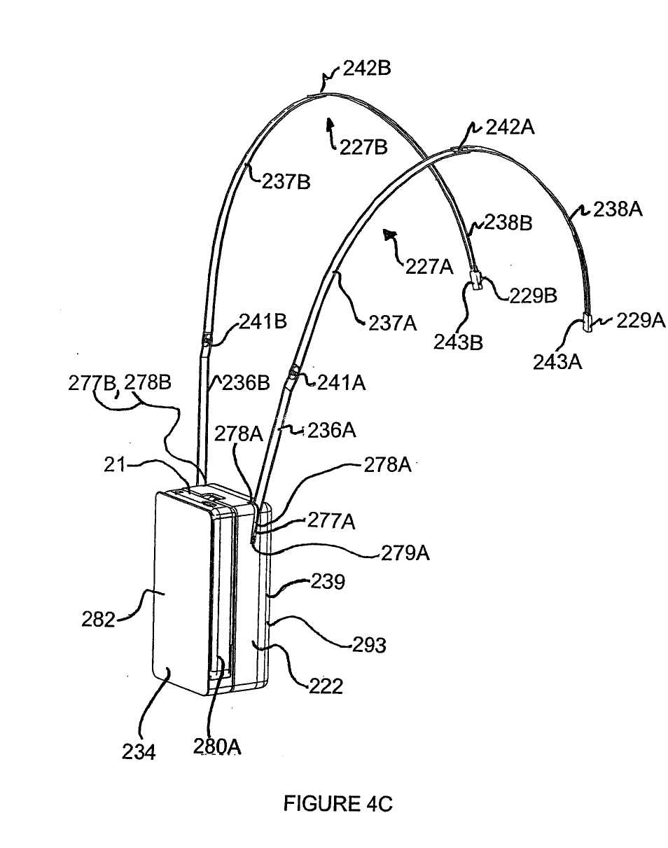

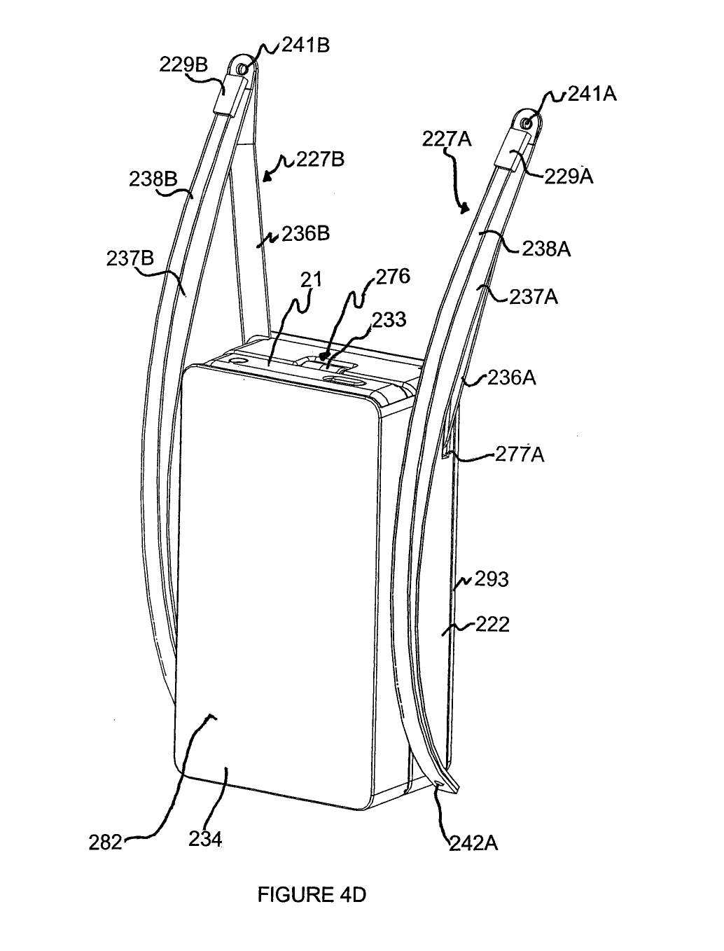

FIGS. 4A-4D show a device-support apparatus 220 according to a third embodiment of the invention in its various configurations. In many respects, device-support apparatus 220 is similar to device-support apparatus 20, 120 discussed above. Features of device-support apparatus 220 that are similar to those of device-support apparatus 20, 120 are accorded similar reference numerals, except that the features of device-support apparatus 220 are preceded by the numeral “2”. Like device-support apparatus 20, 120, device-support apparatus 220 may be adjusted between an expanded configuration (FIG. 4A), an intermediate viewing configuration (FIG. 4B), an intermediate storage configuration (FIG. 4C) and a compact configuration (FIG. 4D). The functionality of each of these configurations is similar in many respects to the corresponding configurations of device-support apparatus 20, 120.

Device-support apparatus 220 incorporates a chest-engaging member 222, a device-support assembly 230 and a device-mounting member 234 that differ in some respects from those of the above-described embodiments. Like the chest-engaging members of device-support apparatus 20, 120, chest-engaging member 222 comprises a pad 293 which provides a rearward surface 239 for engaging the chest 68 of user 50. Chest-engaging member 222 does not incorporate a cradle for housing device 21. Instead, device-mounting member 234 comprises a cradle 275 similar to that of device-mounting member 134. Forward surface 244 of chest-engaging member 222 incorporates a groove 276 for receiving first and second segments 231, 232 of device-support assembly 230 when device-support apparatus 220 is in its intermediate storage configuration and in its compact configuration (see FIGS. 4C, 4D).

In the illustrated embodiment, chest-engaging member 222 incorporates a pair of pivot joints 228A, 228B for pivotally coupling first segments 236A, 236B of arm assemblies 227A, 227B to chest-engaging member 222. Pivot joints 228A, 228B are provided in grooves 277A, 277B on chest-engaging member 222. Groove 277A has groove ends 278A, 279A (FIG. 4C) which limit the range of motion of pivot joint 228A. Groove 277B has similar groove ends which are not visible in the illustrated embodiments. In some embodiments, first segments 236A, 236B of arm assemblies 227A, 227B are integrally formed with or otherwise rigidly connected to chest-engaging member 222.

Pivot joint 225, which pivotally couples chest-engaging member 222 to device-support assembly 230, is located at one end of groove 276. Device-support assembly 230 comprises an elongated first segment 231 pivotally coupled to chest-engaging member 222 via pivot joint 225 at one of its ends and pivotally coupled to second segments 232 via pivot joint 233 at its opposing end. First segment 231 is generally straight (i.e. without the sharp bend 149 of first segment 131). Consequently, when device-support apparatus 220 is adjusted to its intermediate viewing configuration, its intermediate storage configuration and/or its compact configuration, first and second segments 231, 232 of device-support assembly 230 are located in groove 276.

Second segment 232 of device-support assembly is pivotally connected to device-mounting member 234 at pivot joint 235. As mentioned above, device-mounting member 234 comprises a cradle 275. Cradle 275 comprises components 280A, 280B, 281 and 282 which slidably receive device 21. Cradle 275 may provide some protection to device 21 against physical contact. In some embodiments, one or more of cradle components 280A, 280B, 281, 282 may be resilient and may incorporate flanges, lips, ridges, clasps or the like (not shown) which facilitate “snap-in” mounting of device 21. In the illustrated embodiment, cradle components 280A, 280B, 282 extend all the way along the length of device 21. This is not necessary. In some embodiments, cradle components 280A, 280B, 282 extend only part way along the length of device 21.

Adjustment of device-support apparatus 220 between its expanded configuration (FIG. 4A) and its intermediate viewing configuration (FIG. 4B) involves: (i) pivoting second segment 232 relative to first segment 231 about pivot joint 233 in the direction indicated by arrow 247; and (ii) pivoting first segment 231 relative to chest-engaging member 222 about pivot joint 225 in the direction indicated by arrow 248. Adjustment of device-support apparatus 220 between its intermediate viewing configuration (FIG. 4B) and its intermediate storage configuration (FIG. 4C) involves pivoting device-mounting member 234 relative to second segment 232 about pivot joint 235 in the direction indicated by arrow 246.

After removing device-support apparatus 220 from the body 50 of user 52, adjustment of device-support apparatus 220 between its intermediate storage configuration (FIG. 4C) and its compact configuration (FIG. 4D) involves collapsing arm assemblies 227A, 227B by pivoting second and third segments 237A, 237B, 238A, 238B about pivot joints 241A, 241B, 242A, 242B until second and third segments 237A, 237B, 238A, 238B are generally parallel with first segments 236A, 236B. As shown in FIG. 4D, second and third segments 237A, 237B, 238A, 238B of arm assemblies 227A, 227B may be longer than first segments 236A, 236B, such that in the collapsed state, the length of second and third segments 237A, 237B, 238A, 238B is similar to the combined lengths of chest-engaging member 222 and first segments 236A, 236B.

Adjusting device-support apparatus 220 between its compact configuration, through its intermediate storage configuration, through its intermediate viewing configuration and to its expanded configuration involves substantially the reverse procedure.

In other respects, device-support apparatus 220 may be similar to device-support apparatus 20 and/or to device-support apparatus 120.

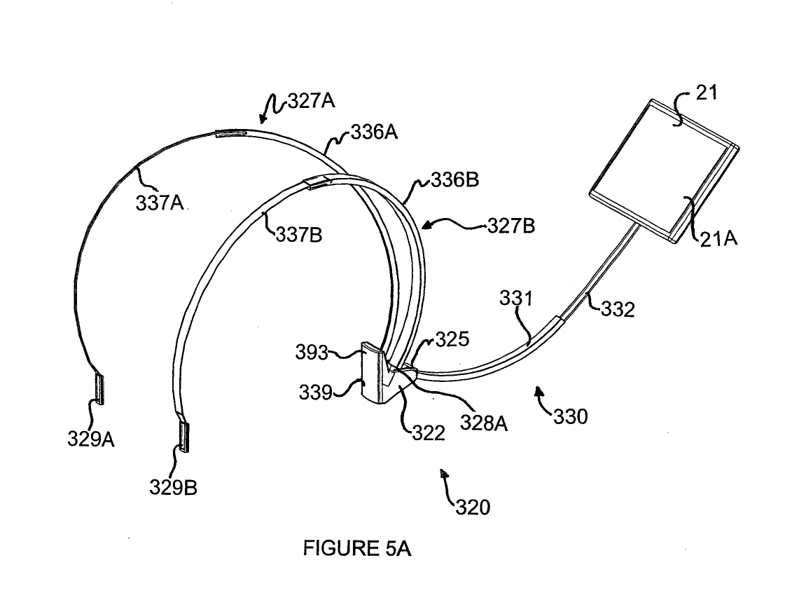

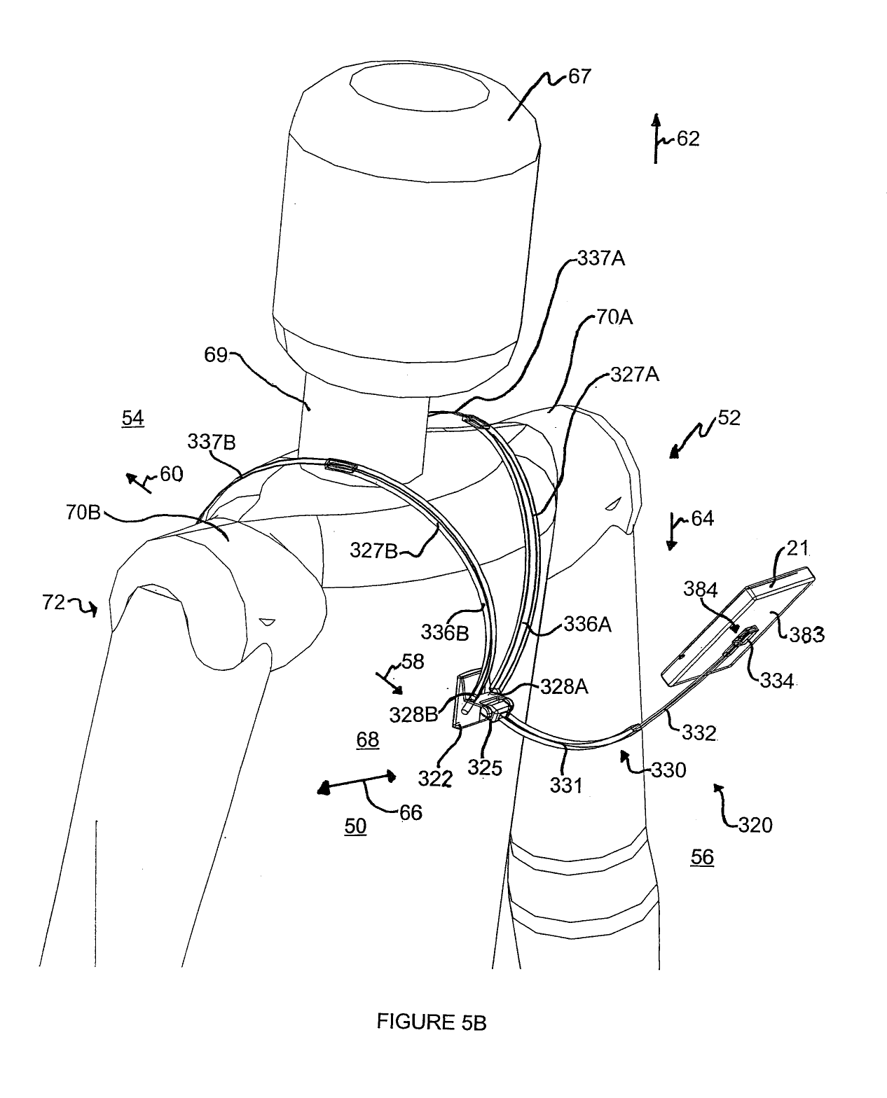

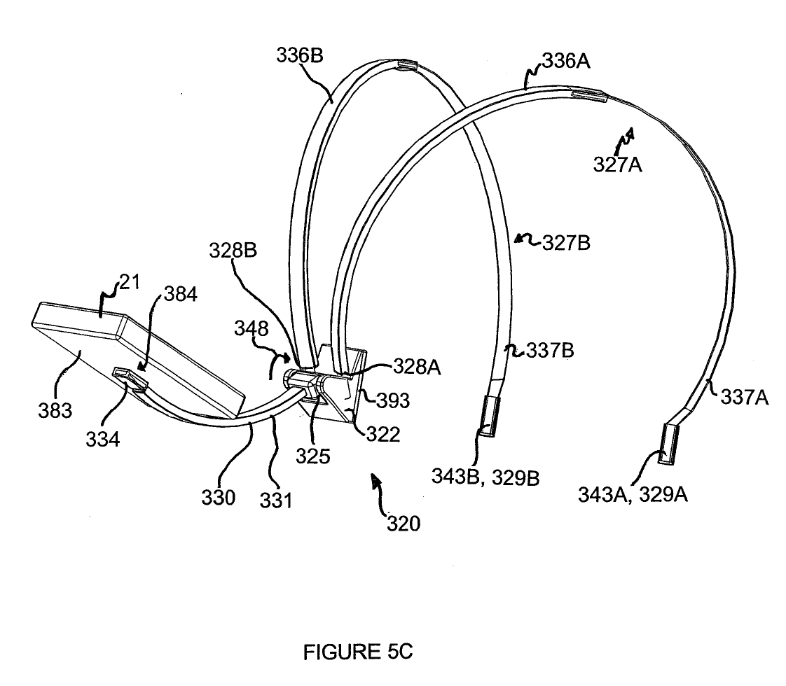

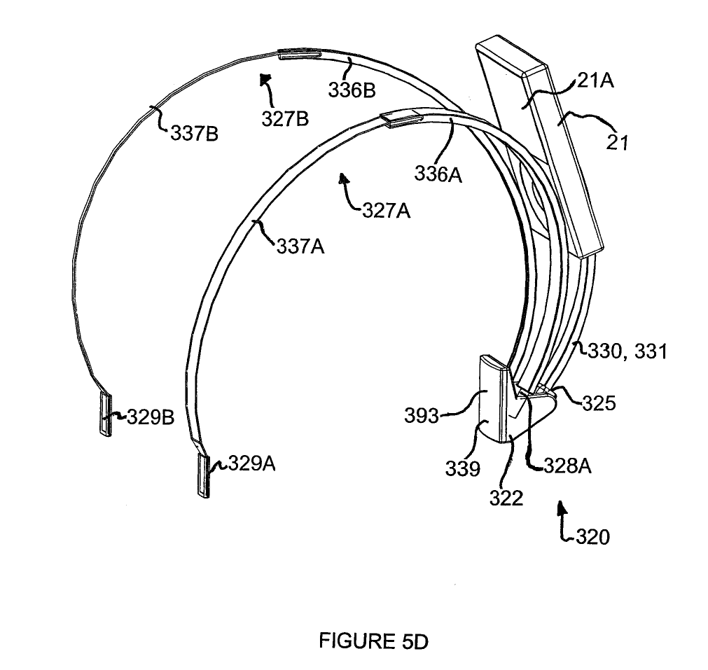

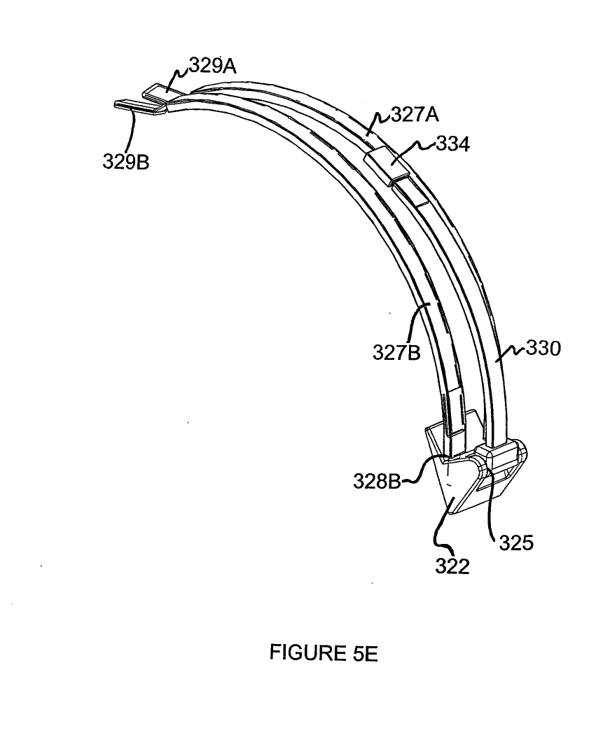

FIGS. 5A-5E show a device-support apparatus 320 according to a fourth embodiment of the invention in its various configurations. In many respects, device-support apparatus 320 is similar to device-support apparatus 20, 120, 220 discussed above. Features of device-support apparatus 320 that are similar to those of device-support apparatus 20, 120, 220 are accorded similar reference numerals, except that the features of device-support apparatus 320 are preceded by the numeral “3”. Like device-support apparatus 20, 120, 220, device-support apparatus 320 may be adjusted between an expanded configuration (FIGS. 5A, 5B), an intermediate viewing configuration (FIG. 5C), an intermediate storage configuration (FIG. 5D) and a compact configuration (FIG. 5E). The functionality of each of these configurations is similar in many respects to the corresponding configurations of device-support apparatus 20, 120, 220.

Device-support apparatus 320 incorporates arm assemblies 327A, 327B, a chest-engaging member 322, a device-support assembly 330 and a device-mounting member 334 that differ in some respects from those of the above-described embodiments. The principal differences between device-support apparatus 320 and the previously described device-support apparatus 20, 120, 220 include:
arm assemblies 327A, 327B incorporate only first and second curved segments 336A, 336B, 337A, 337B which are telescopically coupled to one another, such that second segments 337A, 337B retract into bores (not specifically enumerated) in first segments 336A, 336B when device-support apparatus 320 is adjusted to its compact configuration (FIG. 5E) and second segments 337A, 337B extend from the bores in first segments 336A, 336B when device-support apparatus 320 is adjusted to any of its other configurations (FIGS. 5A-5E);
device-support assembly 330 incorporates first and second curved segments 331, 332 which are telescopically coupled to one another, such that second segment 332 extends from a bore (not specifically enumerated) in first segment 331 when device-support apparatus 320 is adjusted to its expanded configuration (FIGS. 5A, 5B) and second segment 332 retracts into the bore in first segment 331 when device-support apparatus 320 is adjusted to any of its other configurations.

### In alternative embodiments, first segments 336A, 336B of arm assemblies 327A, 327B telescope into bores provided in second segments 337A, 337B. Similarly, first segment 331 of device-support assembly 330 may extend from a bore in second segment 332.

Like the chest-engaging members of device-support apparatus 20, 120, 220, chest-engaging member 322 comprises a pad 393 which provides a rearward surface 339 for engaging the chest 68 of user 50. In the illustrated embodiment, neither chest-engaging member 322 nor device-mounting member 334 provides a cradle for device 21, although device-support apparatus 320 could be modified to provide a cradle similar to any of those described herein. Chest-engaging member 322 incorporates a pair of pivot joints 328A, 328B for moveably coupling first segments 336A, 336B of arm assemblies 327A, 327B to chest-engaging member 322. Unlike the previously described embodiments, pivot joints 328A, 328B pivot about generally vertically oriented axes. In some embodiments, pivot joints 328A, 328B are implemented as spherical joints, as a pair of orthogonal pivot joints or as a universal joints. In still other embodiments, first segments 336A, 336B of arm assemblies 327A, 327B are integrally formed with or otherwise rigidly coupled to chest-engaging member 322.

Device-support assembly 330 comprises an elongated, curved first segment 331 pivotally coupled to chest-engaging member 322 via pivot joint 325 at one of its ends and telescopically coupled to second segments 332 at its opposing end. In the illustrated embodiment, first segment 331 is the female component and second component 332 slides telescopically into and out of a bore in first segment 331. In other embodiments, second segment 332 is the female component and first segment 331 is the male component. Device-support assembly 330 may comprise some form of locking mechanism (not shown) which is adjustable between an unlocked configuration, wherein first and second segments 331, 332 are permitted to move telescopically with respect to one another, and a locked configuration, wherein first and second segments 331, 332 are prevented from moving telescopically with respect to one another. In some embodiments, first and second segments 331, 332 may be designed such that friction prevents relative telescopic movement unless external force is applied by user 52.

In the illustrated embodiment, second segment 332 is rigidly connected to or integrally formed with device-mounting member 334. In other embodiments, a pivot joint, spherical joint, universal joint or the like is provided between second segment 332 and device-mounting member 334 to permit adjustment of device-mounting member 334. As shown best in FIG. 5B, a connector component 383 may be coupled to device 21. Connector component 383 may be removably coupled to device-mounting member 334 to form a joint 384. Joint 382 may be a pivot joint, a spherical joint, a universal joint or the like. Joint 384 allows device 21 to be adjusted between a “portrait” orientation and a “landscape” orientation. In some embodiments, the connection between device-mounting member 334 and connector component 383 may be similar to that shown in FIG. 9. For example, connector component 383 may be a sleeve similar to sleeve 95 or may otherwise incorporate a fastener component similar to male fastener component 96 and device-mounting member 334 may comprise a fastener component similar to female fastener component 97.

Adjustment of device-support apparatus 320 between its expanded configuration (FIGS. 5A, 5B) and its intermediate viewing configuration (FIG. 5C) involves telescopically sliding second segment 332 of device-support assembly 330 into the bore in first segment 331 of device-support assembly 330. Adjustment of device-support apparatus 320 between its intermediate viewing configuration (FIG. 5C) and its intermediate storage configuration (FIG. 5D) involves pivoting first segment 331 about pivot joint 325 in the direction indicated by arrow 348.

After removing device-support apparatus 320 from the body 50 of user 52, adjustment of device-support apparatus 320 between its intermediate storage configuration (FIG. 5D) and its compact configuration (FIG. 5E) involves: (i) decoupling connector component 383 from device-mounting member 334; (ii) collapsing arm assemblies 327A, 327B by telescopically sliding second segments 337A, 337B into the bores in the first segments 336A, 336B; and (iii) moving arm assemblies 327A, 327B toward one another by adjusting pivot joints 328A, 328B.

Adjusting device-support apparatus 320 between its compact configuration, through its intermediate storage configuration, through its intermediate viewing configuration and to its expanded configuration involves substantially the reverse procedure.

In other respects, device-support apparatus 320 may be similar to previously-described device-support apparatus 20, 120, 220.

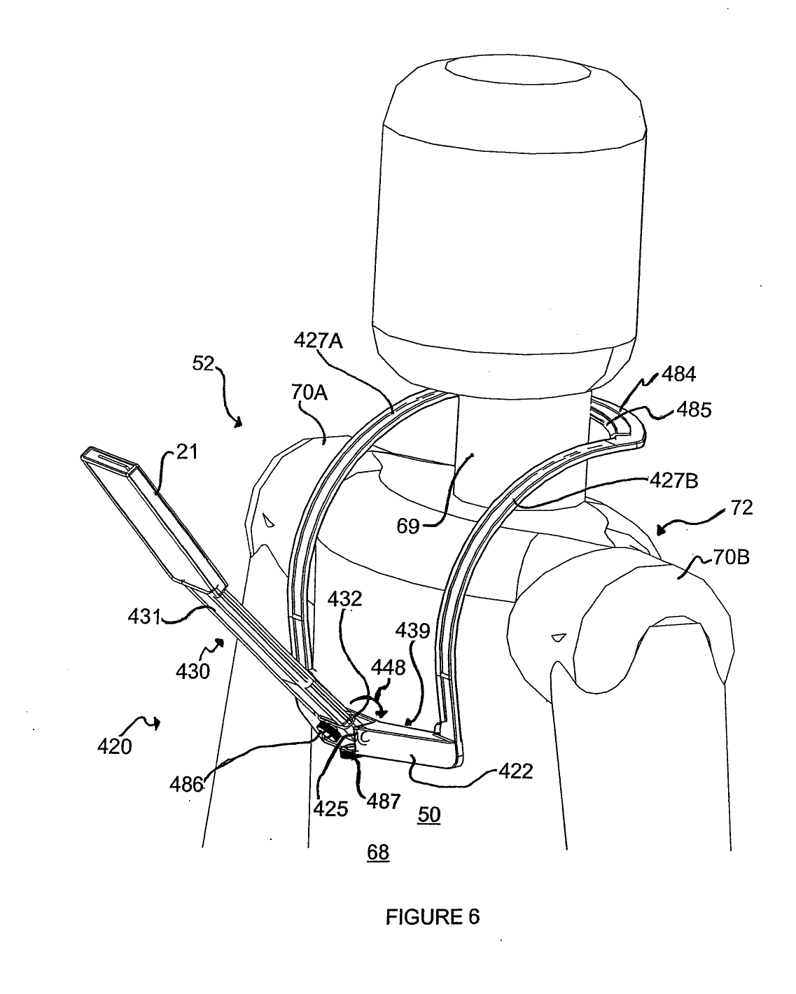

FIG. 6 shows a device-support apparatus 420 in accordance with another embodiment of the invention adjusted to its intermediate viewing configuration. In some respects, device-support apparatus 420 is similar to device-support apparatus 20, 120, 220, 320 discussed above. Features of device-support apparatus 420 that are similar to those of device-support apparatus 20, 120, 220, 320 are accorded similar reference numerals, except that the features of device-support apparatus 420 are preceded by the numeral “4”. Like device-support apparatus 20, 120, 220, 320, device-support apparatus 420 comprises a device-support assembly 430 that is pivotally connected (at pivot joint 425) to a chest-engaging member 422 and a pair of arms 427A, 427B that extend from chest-engaging member 422 over the shoulders 70A, 70B of user 52.

Device-support assembly 430 comprises a first segment 431 which extends generally forwardly and upwardly from chest-engaging member 422. First segment 431 supports device 21 at one of its ends. In some embodiments, first segment 431 comprises a compartment for batteries which may be able to provide power to device 21. Although not specifically shown in FIG. 6, a device-mounting member may be provided at the end of first segment 431 for helping to support device 21. Such a device-mounting member may be similar to any of the device-mounting members discussed herein.

In the FIG. 6 illustration, device-support apparatus 420 is adjusted to its intermediate-viewing configuration. Device-support assembly 430 comprises a second segment 432 which couples first segment 431 to pivot joint 425 on chest-engaging member 422. Second segment 432 may extend telescopically into a bore (not shown) in first segment 431. Adjusting device-support apparatus 420 from its intermediate viewing configuration (shown in FIG. 6) to its expanded configuration (not specifically shown) involves telescopically sliding second segment 432 out of the bore of first segment 431 to extend device-support assembly 430 forwardly and upwardly. In the illustrated embodiment, device-support assembly comprises a locking mechanism 486 which is adjustable between a locked configuration, wherein it prevents sliding movement between first segment 431 and second segment 432, and an unlocked configuration, wherein sliding movement between first segment 431 and second segment 432 is permitted. In the illustrated embodiment, locking mechanism 486 comprises a thumbscrew-type mechanism, but locking mechanism 486 may generally comprise any suitable type of locking mechanism.

Adjusting device-support apparatus 420 from its intermediate viewing configuration (shown in FIG. 6) to its intermediate storage configuration (not specifically shown) involves pivoting device-support assembly 430 relative to chest-engaging member 422 about pivot joint 425 in the direction indicated by arrow 448. In the illustrated embodiment, device-support assembly comprises a locking mechanism 487 which is adjustable between a locked configuration, wherein it prevents pivot movement of pivot joint 425, and an unlocked configuration, wherein pivotal movement of pivot joint 425 is permitted. In other embodiments, pivot joint 425 may be a high friction pivot joint such that locking mechanism 487 is not required.

Rather than having back-engaging members, device-support apparatus 420 comprises a neck-engaging member 484. In the illustrated neck-engaging member 484 extends between arms 427A, 427B. Neck-engaging surface 485 of neck-engaging member 484 may comprise or may otherwise be at least partially coated with deformable pads or the like which increase user comfort where neck-engaging surface 485 contacts neck 69 of user 52.

As with the other embodiments described above, it is not necessary that arms 427A, 427B contact shoulders 70A, 70B or that shoulders 70A, 70B support arms 427A, 427B or device-support apparatus 420. The torque caused by gravity acting on device 21 at the end of device-support assembly 430 tends to pivot device-support apparatus 420 around chest-engaging member 422. However, neck-engaging member 484 contacts the neck 69 of user 52 and prevents any pivoting of device-support apparatus 420. Also, frictional forces between rearward surface 439 of chest-engaging member 422 and chest 68 may prevent chest-engaging member 422 from moving upwardly or downwardly relative to chest 68. Similarly, frictional forces between neck-engaging surface 485 and neck 69 may prevent neck-engaging member 484 from moving upwardly or downwardly.

Device-support apparatus 420 may also be adjusted to its compact configuration (not specifically shown) by removing apparatus 420 from the body 50 of user 52, collapsing device-support assembly 430 and pivoting pivot joint 25 such that device-support assembly 430 is generally aligned with arms 427A, 427B. Removing device-support apparatus 420 from the body 50 of user 52 may involve putting the head 67 of user 52 through the region between chest-engaging member 422, arms 427A, 427B and neck-engaging member 484. In some embodiments, neck engaging member 484 is detachable from at least one of arms 427A, 427B to ease removal of device-support apparatus 420 from the body 50 of user 52.

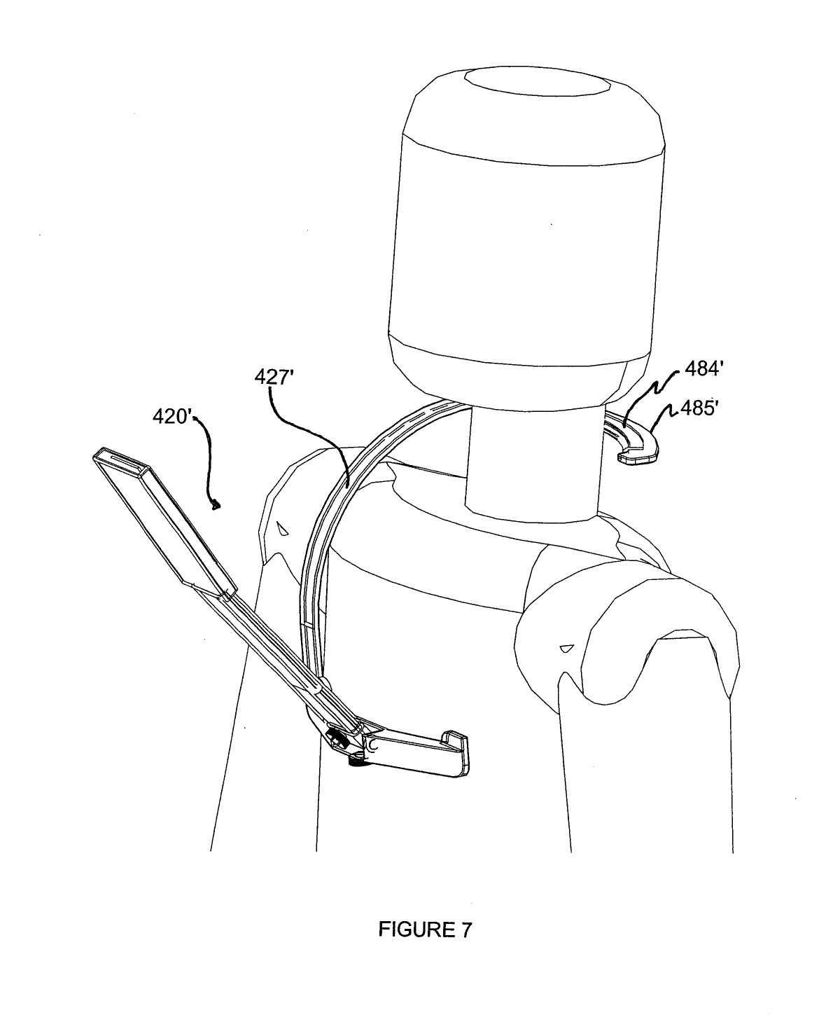

FIG. 7 depicts a device-support apparatus 420′ that incorporates only a single arm 427A′. In other respects, device-support apparatus 420′ is similar to device-support apparatus 420 of FIG. 6.

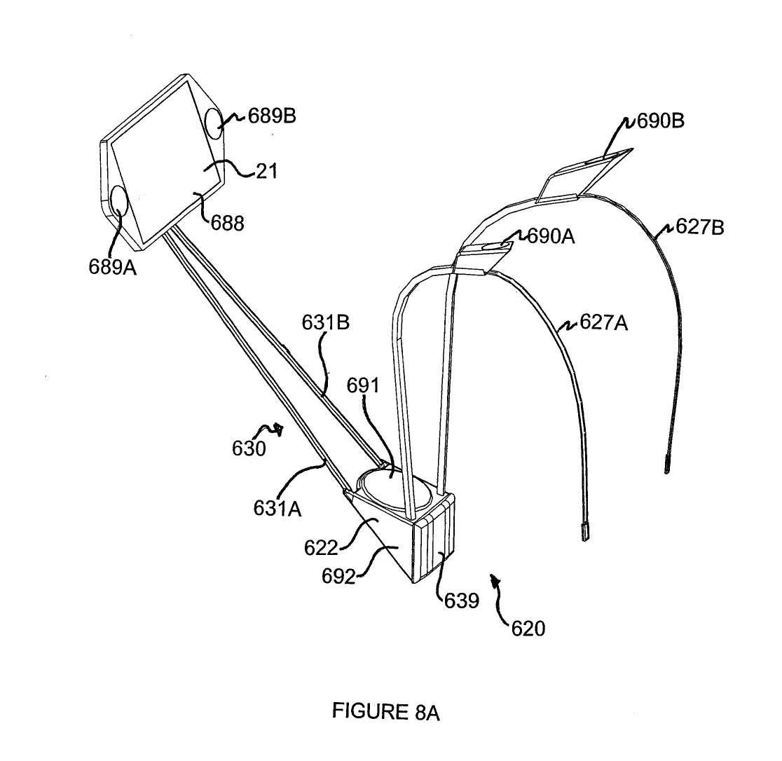

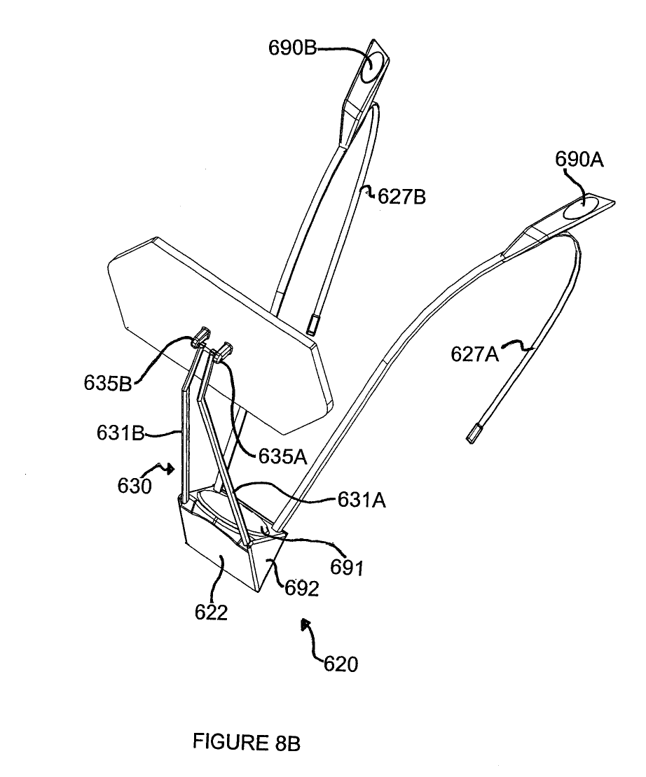

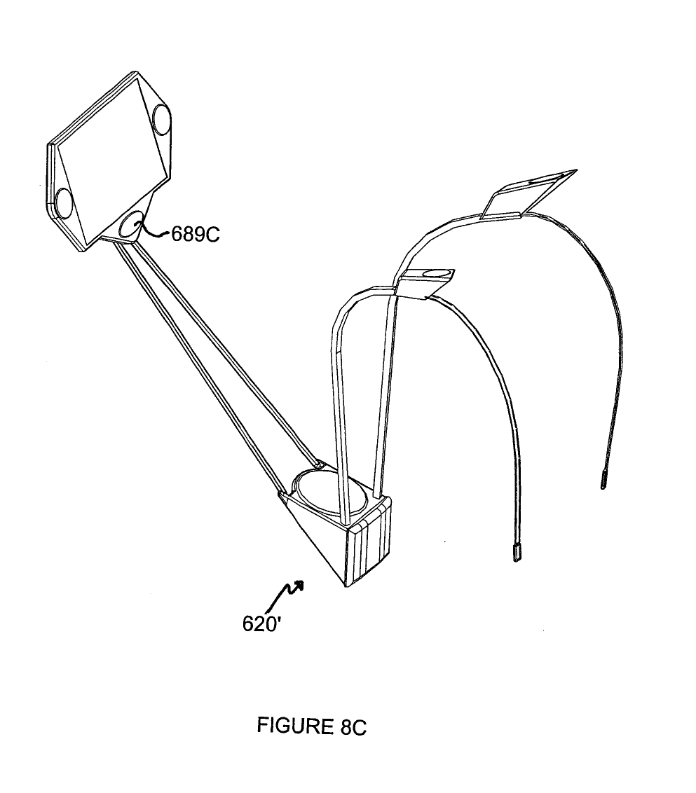

FIGS. 8A and 8B depict a hands-free device-support apparatus 620 according to yet another embodiment of the invention. Device-support apparatus 620 incorporates components which allow it to be used as a personal multimedia entertainment system. In some respects, device-support apparatus 620 may be similar to any one or more of device-support apparatus 20, 120, 220, 320, 420 discussed above. Features of device-support apparatus 620 that are similar to those of device-support apparatus 20, 120, 220, 320, 420 are accorded similar reference numerals, except that the features of device-support apparatus 620 are preceded by the numeral “6”.

In the illustrated embodiment, device-support assembly 630 comprises a pair of device-support members 631A, 631B which are pivotally connected to chest-engaging member 622 via pivot joints 625A, 625B at one end and to a multimedia playback device 21 via pivot joints 635A, 635B at the other end. Alternatively, a device-mounting member (not shown) may be pivotally connected to device-support assembly 630 via pivot joints 635A, 635B and a separate multimedia playback device (not shown) may be mounted to the device-mounting member.

In the illustrated embodiment, arms 627A, 627B are rigidly coupled to, or integrally formed with, chest-engaging member 622. In some embodiments, pivot joints or other adjustable couplings may be provided to couple arms 627A, 627B to chest-engaging member 622. Arms 627A, 627B may also comprise multiple segments coupled to one another by pivot joints to allow the various segments to be folded as in some of the embodiments described above. Arms 627A, 627B may also comprise multiple segments that are telescopically coupled to one another like arm assemblies 327A, 327B of device-support assembly 320.

To be used as a personal multimedia entertainment system, apparatus 620 and/or device 21 comprises one or more transducers for providing a multi-sensory experience similar to a home audio-video system. The transducers provide multiple synchronized channels of information, such as video, multiple channels of audio and possibly tactile vibration. Device 21 comprises a video display 688. In the illustrated embodiment, apparatus 620 may comprise one or more relatively wide range audio transducers 690A, 690B mounted on arms 627A, 627B.

Mounting of audio transducers 690A, 690B on arms 627A, 627B allows the one or more audio transducers 690A, 690B to be located in a vicinity of at least one of the user's ears. In the illustrated embodiment, audio transducers 690A, 690B are mounted to each arm 627A, 627B, such that there is at least one transducer located in a vicinity of each ear. Audio transducers 690A, 690B may be at any elevation from approximately the height of the user's shoulders 70A, 70B up to approximately the height of the user's ears or even higher. In addition, audio transducers 690A, 690B may be placed in any location from in front of the ears to behind the ears. In general, audio transducers 690A, 690B are not required to touch the user's ears, and this may provide enhanced comfort and safety as compared to the use of headphones or earphones. In some embodiments, audio transducers 690A, 690B may contact the user's ears. It is also possible to have a pair of audio transducers 690A, 690B mounted on each arm 627A, 627B such that one transducer is located in front of each of the user's ears and another transducer is located behind each of the user's ears.

Apparatus 620 may also comprise one or more additional audio transducers 689A, 689B that are supported in front of the user. In the illustrated embodiment, a pair of additional transducers 689A, 689B are located on opposed sides of video display 688. Additional transducers 689A, 689B may be located in the same housing as video display 688 or may be separate components. Additional transducers 689A, 689B may be supported by the same device-support assembly 630 that supports device 21. Alternatively, additional transducers 689A, 689B may be supported by arms 627A, 627B or other suitable part of apparatus 620.

Apparatus 620 may also comprise additional audio transducers 691 located within, or proximate to, chest-engaging member 622. Additional transducers 691 may serve an audio channel carrying a relatively low range of frequencies when compared to the frequencies of other audio transducers 689A, 689B, 690A, 690B. Additional transducers 691 may be particularly suitable for supplying low frequencies because low frequency audio transducers tend to be relatively heavy and a relatively greater weight may be comfortably supported near chest-engaging member 622 than at most other locations on apparatus 620. In addition, this location is generally symmetrically located with respect to the user's ears, making it an ideal location if the media content is encoded with a single low frequency channel as is often the case for the material intended to go to a sub-woofer. If there is not a dedicated channel of audio information encoded in the media, it may be possible to create one by low-pass filtering the other channels and mixing the resulting signals, a technique well known in the art of audio electronic design.

Apparatus 620 may include a vibratory device 692 capable of imparting vibration to chest-engaging member 622. In the illustrated embodiment, vibratory device 692 is mounted to chest-engaging member 622, although apparatus 620 may comprise one or more vibratory devices 692 at other locations. Vibratory device 692 may be a rotary vibrator, a moving-magnet vibrator, or any other suitable type of vibratory device. In some embodiments, vibration may be provided directly by the vibration of a low-audio-frequency transducer (e.g. additional audio transducer 691). When vibratory device 692 is activated, user 52 may feel or sense the intensity and/or frequency of vibration through chest-engaging member 622 (or through one or more other suitable contact points), and this may provide a sensation analogous to the sub-woofer of a home media playback system. Vibratory device 692 may be configured to be activated by low frequencies that are in the audio content or that are sent to the sub-woofer channel. Additionally or alternatively, vibratory device 692 may be activated by the “rumble” signal that is used in video gaming systems to activate a vibratory device in the game pad or game controller.

It may be desirable for some or all of the audio transducers 689A, 689B, 690A, 690B, 691 to be directional, so that they emit sound in a relatively narrow cone directly toward the user's ears, and relatively little sound is dispersed in other directions. Directional audio transducers may allow users of apparatus 620 to use apparatus 620 without unduly disturbing others. Techniques for designing audio transducers with narrow angles of dispersion are well known by individuals skilled in the art of audio transducer system design.

FIG. 8C depicts an apparatus 620′ that differs from apparatus 620 (of FIGS. 8A and 8B) in that apparatus 620′ incorporates an additional center channel speaker 689C.

Device 21 may play back media content using apparatus 620, 620′. Apparatus 620, 620′ may implement a personal 5.1 channel surround sound system. In the illustrated embodiment, apparatus 620, 620′ comprises: video display 688; speakers 690A, 690b for left and right rear channels; additional speakers 689A, 689B for left and right audio channels and optional center speaker 689C for an optional center audio channel; speaker 691 for the sub-woofer channel; and optional vibratory device 695 configured to vibrate with amplitude and frequency based on the frequencies received on the sub-woofer channel. In the case where the media is stereo material containing only left and right channels, it may be possible to synthesize the center, low frequency and rear channels. As a non-limiting example, the rear channels may be fed synthesized material capable of simulating reverberation or environmental ambiance. These channel synthesis techniques are well known to those skilled in the art of designing multi-channel audio entertainment systems.

Apparatus 620, 620′ may be provided with a connector for the user to plug in head mounted audio transducers such as headphones or in-ear transducers. When plugged into apparatus 620, 620′ the sound from some or all of the main transducers may be silenced, allowing the user to view video display 688 and listen to audio content without disturbing others. Often, a disadvantage of listening to content through head-mounted audio transducers is that low frequencies may be perceived less intensely, because these small transducers do not produce low frequencies efficiently. To overcome this issue, the low frequency transducer(s), for example transducer 691 and/or the vibratory device 692 of apparatus 620, 620′, may remain active when the headphones are plugged in. This may allow the user to more intensely perceive the low frequency or tactile content of the media with little or no disturbance to others.

In one particular embodiment, video display 688 may be of a type designed to display three-dimensional (3D) content. Apparatus 620, 620′ described above is particularly suitable for this type of 3D display technology because 3D display systems work best if the display is at a reasonably predictable and constant orientation and distance with respect to the eyes. In addition, such 3D display devices may tend to have relatively small viewing angles. The display of the disclosed apparatus provides a narrow and almost constant viewing angle because the viewer's head position is directly in front of the display.

There are at least three example embodiments of apparatus 620, 620′ in terms of its relationship to the source of the content. In a first example, apparatus 620, 620′ includes its own sound system and optional display, but is used to show content sent to apparatus 620, 620′ from an external source. Content may be relayed to apparatus 620, 620′ from the external source by electric cable (such as S-Video and standard audio cables), optical cable (such as Optical 5.1), wireless protocol such as IEEE 802.11, H.236, WiFi™, Bluetooth™, or any other suitable means. In such systems, apparatus 620, 620′ may be provided with an antenna and suitable wireless communications hardware. Content sources may include, as non limiting examples: home entertainment systems; home game consoles; personal computers; portable media players; portable game players; portable or handheld computers; portable communication devices; and/or any other device capable of providing audio and/or video content.

In a second example, apparatus 620, 620′ includes its own sound system, but provides a place to mount in front of the user a compact portable device 21 that has its own video playback display. In this example, device 21 incorporating the display may also be the source of the content to be played by apparatus 620, 620′. For example, suitable devices might include, without limitation, handheld media players, handheld gaming devices, handheld computers or the like. Apparatus 620, 620′ may be connected to the media device's audio output, and may include amplification of the audio signal as required to drive the audio transducers on apparatus 620, 620′. Apparatus 620, 620′ may also include a battery to power the amplification and audio transducers. In a modified version of this example, apparatus 620, 620′ includes its own sound system and provides a place for mounting a compact portable audio playback device 21 (i.e. without video playback). Audio playback device 21 may also be the source of the content to be played by apparatus 620, 620′.

In a third example, apparatus 620, 620′ includes its own sound system and optional display, and also includes a built-in device for the storage and/or playback of media content. The built-in device may be able to store and/or play-back media content from suitable memory devices and/or media, such as, without limitation, built-in compact flash memory, a built-in compact hard disc drive, removable compact flash cards, removable optical storage discs, or other suitable memory devices and/or media. Apparatus 620, 620′ may also include a battery to power the amplification and audio transducers.

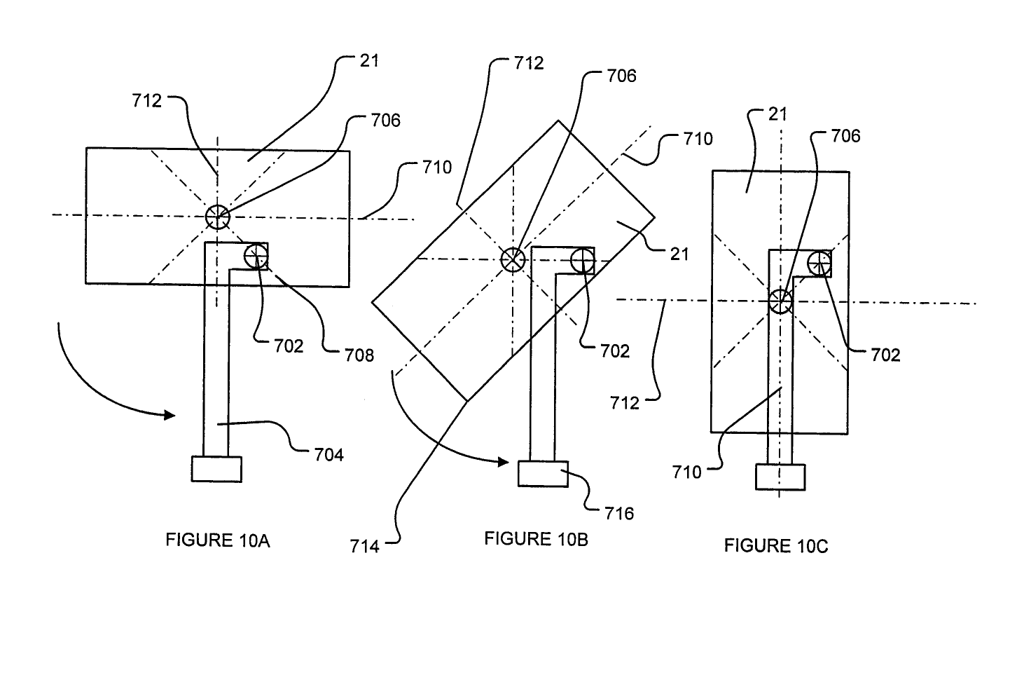

While a number of exemplary aspects and embodiments have been discussed above, those of skill in the art will recognize certain modifications, permutations, additions and sub-combinations thereof. For example:
Various embodiments of device-support apparatus are described above. Those skilled in the art will appreciate that many of these embodiments contain components that are interchangeable with similar components from other embodiments. By way of non-limiting example, device-support assembly 330 of device-support apparatus 320 incorporating telescoping segments may be implemented on device-support apparatus 20. Similar interchanging of components may occur with other components, such as arm assemblies, device-mounting members and the like.
In the embodiments described above, device-mounting members are described as being coupled to device-support assemblies via pivot joints. In some embodiments, these pivot joints may be replaced by universal joints or spherical joints, which allow relative movement between device-mounting members and device-support assemblies about multiple axes. A similar effect may be achieved by adding an orthogonal pivot joint between device-mounting members and device-support assemblies. Joints of this nature allow device-mounting members (and device 21) to be adjusted between orthogonal “portrait” and “landscape” orientations. In some embodiments, the chest-engaging member may comprise a compartment for batteries which may be able to provide power to device 21 (e.g. for recharging the batteries of device 21 and/or for operating device 21). In some embodiments, a portion of the electronics of device 21 may be housed in the chest-engaging member. By way of non-limiting example, wireless communication components, means for inputting information into the device (e.g. buttons, switches or the like) or means for receiving information output by the device may be housed in chest-engaging member.
In some embodiments, a separate battery-housing compartment or electronics-housing compartment may be provided and may be releasably coupled to the chest-engaging member (e.g. to an underside of the chest-engaging member). By way of non-limiting example, a releasable coupling between the chest-engaging member and such a compartment may include a deformable “snap-together” coupling or a tongue and groove coupling or the like. In these embodiments, electrical contacts may run from the chest-engaging member (or the compartment) to the device through or along the device-support assembly (e.g. through wires that run through bores or grooves in the segments of the device-support assembly, through wires that run along the segments of the device-support assembly or through the device-support assembly itself).
The arms and/or the device-support assembly may be removably coupled to the chest-engaging member such that the device-support apparatus can be compacted even further.
In the above-described embodiments, the device-support assemblies of the various device-support apparatus comprise a pair of segments which are pivotally or telescopically coupled to one another. In other embodiments, the device-support assemblies may comprise any suitable number of segments (including a single segment) and such segments may be coupled to one another using any of the above-described techniques. Similarly, in the above-described embodiments, the arms/arm assemblies of the various device-support apparatus comprise either one, two or three segments which are pivotally or telescopically coupled to one another. In other embodiments, the arm assemblies may generally comprise any number of segments (including a single segment) and such segments may be coupled to one another using any of the above-described techniques.
Device-support apparatus 620 described above incorporates a number of multimedia transducers which allow it to act as a multimedia playback device. The other device-support apparatus disclosed herein could be modified to provide similar multimedia transducers.
In some embodiments, the device-support apparatus disclosed herein may be used to support mouth-operated input devices, such as those disclosed in co-owned U.S. patent application No. 60/738,966, which is hereby incorporated herein by reference.
In some of the above-discussed embodiments, device 21 is pivotally coupled to a device-mounting member in such a manner that device 21 may be pivoted between landscape and portrait orientations. In the landscape orientation, a first axis (typically a longer axis) of device 21 is oriented horizontally and a second, orthogonal axis (typically a shorter axis) is oriented vertically. In the portrait orientation, the first axis is oriented vertically and the second, orthogonal axis is oriented horizontally. In some embodiments, the pivotal coupling between device 21 and the device-mounting member has a center of rotation that is spaced-apart from the center of device 21. In particular embodiments, the pivotal coupling between device 21 and the device mounting member has a center of rotation that is located on a line that forms a 45° angle with both the first axis and the second, orthogonal axis of device 21. In other words, the device-mounting pivot joint may be equally transversely and vertically spaced from a center of device 21. Such an embodiment (shown in FIGS. 10A-10C) can help to allow device 21 to pivot between its landscape and portrait configurations without interfering with the other parts of the device-support assembly. FIG. 10A depicts device 21 in its landscape configuration. Pivotal joint 702 between device 21 and device-support member 704 has a center of rotation that is spaced-apart from the center 706 of device 21 on a line 708 that forms a 45° angle with both first axis 710 and second, orthogonal axis 712 (i.e. pivot joint 702 is equally transversely and vertically spaced from center 706 of device 21). As pivot joint 702 begins to pivot device 21 towards its portrait configuration, lowermost corner 714 of device 21 is prevented from contacting the other components of device-support assembly 716 (see FIG. 10B). In FIG. 10C, device 21 is in its portrait configuration. Any of the device-support apparatus discussed above, may be coupled to a device in this manner.
In some embodiments, device-mounting member 34 may be provided by a protective case (e.g. a hard plastic case) which incorporates one or more fasteners for coupling to device-support assembly 30. For example, such a protective case may be provided with a pair of hinge pins on its transverse sides which could be used to pivotally couple device 21 to corresponding female hinge members on device-support assembly 30. Such a case may be provided with other types of pivoting or non-pivoting fastener components.
It is not necessary that the device-support apparatus have arms that extend over the user's shoulders. In some embodiments, the chest-engaging member may be supported and/or suspended against the user's chest using other suitable apparatus, such as a harness, a belt, an item of clothing or any other means for suspending and/or supporting the chest-engaging member.

It is therefore intended that the following appended claims and claims hereafter introduced are interpreted to include all such modifications, permutations, additions and sub-combinations as are within their true spirit and scope.

What is claimed is:

1. An apparatus for supporting an electronic device in front of the body of a user, the apparatus comprising:
a chest-engaging member;
a first back-engaging member;
at least one resiliently deformable first arm coupling the chest-engaging member to the first back-engaging member, wherein resilient deformation of the at least one first arm biases the chest-engaging member and the first back-engaging member toward one another;
a device-support assembly coupled to the chest-engaging member for supporting the device in front of the body of the user;
the apparatus adjustable to an expanded configuration wherein the device-support assembly extends forwardly from the chest-engaging member to support the device at a location that is forwardly spaced-apart from the chest-engaging member by a distance greater than about 12 cm; and
the apparatus adjustable to an intermediate storage configuration wherein the device-support assembly is collapsed to support the device at a location that is forwardly spaced-apart from the chest-engaging member by a distance less than about 8 cm.

2. An apparatus according to claim 1 wherein the at least one resiliently deformable first arm extends between the chest-engaging member and the first back-engaging member over at least one of the user's shoulders along a path that is spaced-apart from the at least one of the user's shoulders.

3. An apparatus according to claim 1 wherein the device-support assembly comprises a first pivot joint and the apparatus is adjustable from the intermediate storage configuration to an intermediate viewing configuration by pivoting the first pivot joint and wherein, when the apparatus is in the intermediate viewing configuration, a first portion of the device is forwardly spaced-apart from the chest-engaging member by less than about 5 cm and a second portion of the device is forwardly spaced apart from the chest-engaging member by more than about 5 cm.

4. An apparatus according to claim 3 wherein, when the apparatus is in the intermediate viewing configuration, a user interface of the device is spaced forwardly from the chest-engaging member and oriented to display at least partially upwardly such that the user interface is viewable by the user.

5. An apparatus according to claim 1 wherein, when the apparatus is in the intermediate storage configuration:
a user interface of the device is generally aligned with at least one of:
the chest-engaging member, the at least one first arm and a chest of the user; and
the user interface is forwardly spaced-apart, by less than about 2 cm, from at least one of: the chest-engaging member, the at least one first arm and the chest of the user.

6. An apparatus according to claim 1 comprising a device-mounting member for coupling the device to the device-support assembly, the device-mounting member adjustable to support the device in:
a landscape configuration, wherein a first axis passing through a center of the device is oriented generally transversely and a second orthogonal axis passing through the center of the device is oriented at least partially vertically; and
a portrait configuration, wherein the second orthogonal axis is oriented generally transversely and the first axis is oriented at least partially vertically.

7. An apparatus according to claim 6 wherein the device-mounting member comprises a device-mounting pivot joint, the device-mounting pivot joint having a center of rotation spaced-apart from the center of the device in a direction that is at least one of: a direction parallel with the first axis and a direction parallel with the second orthogonal axis.

8. An apparatus according to claim 7 wherein the center of rotation is located at a point that is equally spaced-apart from the center of the device in the direction parallel with the first axis and in the direction parallel with the second orthogonal axis.

9. An apparatus according to claim 1 wherein the chest-engaging member comprises a recess and wherein, when the apparatus is in the intermediate storage configuration, at least a portion of the device-support assembly is located in the recess.

10. An apparatus according to claim 1 wherein, when the apparatus is in the intermediate storage configuration, the device-support assembly is located forwardly of the device.

11. An apparatus according to claim 1 wherein, when the apparatus is in the intermediate storage configuration, the device-support assembly is located rearwardly of the device.

12. An apparatus according to claim 2 wherein the device-support assembly comprises a first pivot joint and the apparatus is adjustable from the intermediate storage configuration to an intermediate viewing configuration by pivoting the first pivot joint and wherein, when the apparatus is in the intermediate viewing configuration, a first portion of the device is forwardly spaced-apart from the chest-engaging member by less than about 5 cm and a second portion of the device is forwardly spaced apart from the chest-engaging member by more than about 5 cm.

13. An apparatus according to claim 12 wherein, when the apparatus is in the intermediate viewing configuration, a user interface of the device is spaced forwardly from the chest-engaging member and oriented to display at least partially upwardly such that the user interface is viewable by the user.

14. An apparatus according to claim 13 wherein, when the apparatus is in the intermediate storage configuration:
the user interface is generally aligned with at least one of: the chest-engaging member, the at least one first arm and a chest of the user; and
the user interface is forwardly spaced-apart, by less than about 2 cm, from at least one of: the chest-engaging member, the at least one first arm and the chest of the user.

15. An apparatus according to claim 14 comprising a device-mounting member for coupling the device to the device-support assembly, the device-mounting member adjustable to support the device in:
a landscape configuration, wherein a first axis passing through a center of the device is oriented generally transversely and a second orthogonal axis passing through the center of the device is oriented at least partially vertically; and
a portrait configuration, wherein the second orthogonal axis is oriented generally transversely and the first axis is oriented at least partially vertically.

16. An apparatus according to claim 15 wherein the chest-engaging member comprises a recess and wherein, when the apparatus is in the intermediate storage configuration and the intermediate viewing configuration, at least a portion of the device-support assembly is located in the recess.

17. An apparatus according to claim 15 wherein, when the apparatus is in the intermediate storage configuration and the intermediate viewing configuration, the device-support assembly is located forwardly of the device.

18. An apparatus according to claim 15 wherein, when the apparatus is in the intermediate storage configuration and the intermediate viewing configuration, the device-support assembly is located rearwardly of the device.

19. An apparatus according to claim 4 wherein, when the apparatus is in the intermediate storage configuration:
the user interface is generally aligned with at least one of: the chest-engaging member, the at least one first arm and a chest of the user; and
the user interface is forwardly spaced-apart, by less than about 2 cm, from at least one of: the chest-engaging member, the at least one first arm and the chest of the user.

20. An apparatus according to claim 19 comprising a device-mounting member for coupling the device to the device-support assembly, the device-mounting member adjustable to support the device in:
a landscape configuration, wherein a first axis passing through a center of the device is oriented generally transversely and a second orthogonal axis passing through the center of the device is oriented at least partially vertically; and
a portrait configuration, wherein the second orthogonal axis is oriented generally transversely and the first axis is oriented at least partially vertically.

21. An apparatus according to claim 20 wherein the at least one resiliently deformable first arm extends between the chest-engaging member and the first back-engaging member over at least one of the user's shoulders along a path that is spaced-apart from the at least one of the user's shoulders.

22. An apparatus according to claim 21 wherein the chest-engaging member comprises a recess and wherein, when the apparatus is in the intermediate storage configuration and the intermediate viewing configuration, at least a portion of the device-support assembly is located in the recess.

23. An apparatus according to claim 21 wherein, when the apparatus is in the intermediate storage configuration and the intermediate viewing configuration, the device-support assembly is located forwardly of the device.

24. An apparatus according to claim 21 wherein, when the apparatus is in the intermediate storage configuration and the intermediate viewing configuration, the device-support assembly is located rearwardly of the device.

25. An apparatus according to claim 5 wherein the device-support assembly comprises a first pivot joint and the apparatus is adjustable from the intermediate storage configuration to an intermediate viewing configuration by pivoting the first pivot joint and wherein, when the apparatus is in the intermediate viewing configuration, a first portion of the device is forwardly spaced-apart from the chest-engaging member by less than about 5 cm and a second portion of the device is forwardly spaced apart from the chest-engaging member by more than about 5 cm.

26. An apparatus according to claim 25 wherein, when the apparatus is in the intermediate viewing configuration, the user interface is spaced forwardly from the chest-engaging member and oriented to display at least partially upwardly such that the user interface is viewable by the user.

27. An apparatus according to claim 26 wherein the at least one resiliently deformable first arm extends between the chest-engaging member and the first back-engaging member over at least one of the user's shoulders along a path that is spaced-apart from the at least one of the user's shoulders.

28. An apparatus according to claim 1 wherein the device support assembly comprises a plurality of elongated segments, each of the segments coupled to a neighboring segment by a moveable joint.

29. An apparatus according to claim 28 comprising a device-mounting member for coupling the device to the device-support assembly and wherein the plurality of segments comprises: a first segment coupled to the chest-engaging member by a first moveable joint; and a second segment coupled to the first segment by a second moveable joint and coupled to the device-mounting member by a third moveable joint.

30. An apparatus according to claim 29 wherein, when the apparatus is adjusted to the intermediate storage configuration, the first and second segments extend away from the second moveable joint in the same general direction.

31. An apparatus according to claim 30 wherein, the apparatus is adjustable from the intermediate storage configuration to an intermediate viewing configuration by moving the third movable joint and wherein, when the apparatus is in the intermediate viewing configuration, a first portion of the device is forwardly spaced-apart from the chest-engaging member by less than about 5 cm and a second portion of the device is forwardly spaced apart from the chest-engaging member by more than about 5 cm.

32. An apparatus according to claim 30 wherein, the apparatus is adjustable from the intermediate storage configuration to an intermediate viewing configuration by moving the first movable joint and wherein, when the apparatus is in the intermediate viewing configuration, a first portion of the device is forwardly spaced-apart from the chest-engaging member by less than about 5 cm and a second portion of the device is forwardly spaced apart from the chest-engaging member by more than about 5 cm.

33. An apparatus according to claim 1 wherein the device-support assembly comprises a plurality of elongated segments, each of the segments telescopically coupled to a neighboring segment.

34. An apparatus according to claim 33 comprising a device-mounting member for coupling the device to the device-support assembly and wherein the plurality of segments comprises: a first segment coupled to the chest-engaging member by a first moveable joint; and a second segment telescopically coupled to the first segment and moveably coupled to the device-mounting member by a second movable joint.

35. An apparatus according to claim 34 wherein, when the apparatus is adjusted to the intermediate storage configuration, the telescopic coupling between the first and second segments is in a contracted state where one of the first and second segments extends at least one of:
into a bore in the other one of the first and second segments; and
in a parallel and overlapping extension alongside the other one of the first and second segments;
in a parallel and overlapping extension along a groove in the other one of the first and second segments;
by an amount greater than 50% of a length of the one of the first and second segment; and wherein, when the apparatus is adjusted to the expanded configuration, the telescopic coupling between the first and second segments is in an expanded state where at least one of:
the extension of the one of the first and second segments into the bore of the other one of the first and second segments is by an amount less than 10% of the length of the one of the first and second segments; and
the parallel and overlapping extension of the one of the first and second segments alongside the other one of the first and second segments is by an amount less than 10% of the length of the one of the first and second segments; and
the parallel and overlapping extension of the one of the first and second segments along the groove in the other one of the first and second segments is by an amount less than 10% of the length of the one of the first and second segments.

36. An apparatus according to claim 1 comprising a second back engaging member and at least one resiliently deformable second arm coupling the chest-engaging member to the second back-engaging member, wherein resilient deformation of the at least one second arm biases the chest-engaging member and the second back-engaging member toward one another and wherein the at least one first arm extends between the chest-engaging member and the first back-engaging member over a first one of the user's shoulders along a path that is spaced-apart from the first one of the user's shoulders and the at least one second arm extends between the chest-engaging member and the second back-engaging member over a second one of the user's shoulders along a path that is spaced-apart from the second one of the user's shoulders.

37. An apparatus according to claim 36 wherein the first and second arms comprise first and second arm assemblies, each of the first and second arm assemblies comprising a plurality of segments wherein each segment has a generally elongated shape and is coupled to its neighboring segment by a moveable joint.

38. An apparatus according to claim 37 wherein, for each of the first and second arm assemblies, the plurality of segments comprises:
a first segment coupled to the chest-engaging member;
a second segment coupled to the first segment by a first moveable joint; and
a third segment coupled to the second segment by a second moveable joint and also coupled to a corresponding one of the first and second back-engaging members.

39. An apparatus according to claim 38 wherein the apparatus is removable from the body of the user and adjustable to a compact configuration wherein the first and second segments extend away from the first moveable joint in the same general direction and the second and third segments extend away from the second moveable joint in the same general direction.

40. An apparatus according to claim 38 wherein, for each of the first and second arm assemblies, the plurality of segments comprises:
a first segment coupled to the chest-engaging member; and
a second segment coupled to the first segment by a first moveable joint and also coupled to a corresponding one of the first and second back-engaging members.

41. An apparatus according to claim 40 wherein the apparatus is removable from the body of the user and adjustable to a compact configuration wherein the first and second segments extend away from the first moveable joint in the same general direction.

42. An apparatus according to claim 36 wherein the first and second arms comprise first and second arm assemblies, each of the first and second arm assemblies comprising a plurality of segments wherein each segment is telescopically coupled to its neighboring segment.

43. An apparatus according to claim 36 wherein the chest-engaging member comprises a rearward facing surface having a coefficient of friction greater than or equal to about 0.5.

44. An apparatus according to claim 36 wherein the first and second back-engaging members each comprise a forward facing surface having a coefficient of friction greater than or equal to about 0.5.

45. An apparatus for supporting an electronic device in front of the body of a user, the apparatus comprising:
a chest-engaging member;
means for supporting the chest-engaging member against a chest of the user;
a device-support assembly coupled to the chest-engaging member for supporting the device in front of the body of the user;
the apparatus adjustable to an expanded configuration wherein the device-support assembly extends forwardly from the chest-engaging member to support the device at a location that is forwardly spaced-apart from the chest-engaging member by a distance greater than about 12 cm; and
the apparatus adjustable to an intermediate storage configuration wherein the device-support assembly is collapsed to support the device such that a user interface of the device is generally aligned with the chest-engaging member and the user interface is forwardly spaced-apart from the chest-engaging member by less than about 5 cm.

46. An apparatus according to claim 45 wherein the device-support assembly comprises a first pivot joint and the apparatus is adjustable from the intermediate storage configuration to an intermediate viewing configuration by pivoting the first pivot joint and wherein, when the apparatus is in the intermediate viewing configuration:
a first portion of the device is forwardly spaced-apart from the chest-engaging member by less than about 5 cm and a second portion of the device is forwardly spaced apart from the chest-engaging member by more than about 5 cm; and
the user interface is spaced forwardly from the chest-engaging member and oriented to display at least partially upwardly such that the user interface is viewable by the user.

47. An apparatus for supporting an electronic device in front of the body of a user, the apparatus comprising:
a chest-engaging member;
first and second resiliently deformable arms respectively coupling the chest-engaging member to first and second back-engaging members, wherein resilient deformation of the first arm biases the chest-engaging member and the first back-engaging member toward one another and resilient deformation of the second arm biases the chest-engaging member and the second back-engaging member toward one another; and
a device-support assembly coupled to the chest-engaging member for supporting the device in front of the body of the user;
wherein the first arm extends between the chest-engaging member and the first back-engaging member over a first one of the user's shoulders along a path that is spaced-apart from the first one of the user's shoulders and the second arm extends between the chest-engaging member and the second back-engaging member over a second one of the user's shoulders along a path that is spaced-apart from the second one of the user's shoulders.

48. An apparatus according to claim 47 wherein the apparatus is adjustable to an expanded configuration where the device-support assembly extends forwardly from the chest-engaging member to support the device at a location that is forwardly spaced-apart from the chest-engaging member by a distance greater than about 12 cm and wherein the apparatus is adjustable to an intermediate storage configuration where the device-support assembly is collapsed to support the device at a location that is forwardly spaced-apart from the chest-engaging member by a distance less than about 8 cm.

49. An apparatus according to claim 47 wherein the apparatus is adjustable to an expanded configuration wherein the device-support assembly extends forwardly from the chest-engaging member to support the device at a location that is forwardly spaced-apart from the chest-engaging member by a distance greater than about 12 cm and the apparatus is adjustable to an intermediate storage configuration wherein the device-support assembly is collapsed to support the device such that a user interface of the device is generally aligned with the chest-engaging member and the user interface is forwardly spaced-apart from the chest-engaging member by less than about 5 cm.

50. An apparatus according to claim 49 wherein the device-support assembly comprises a first pivot joint and the apparatus is adjustable from the intermediate storage configuration to an intermediate viewing configuration by pivoting the first pivot joint and wherein, when the apparatus is in the intermediate viewing configuration:
a first portion of the device is forwardly spaced-apart from the chest-engaging member by less than about 5 cm and a second portion of the device is forwardly spaced apart from the chest-engaging member by more than about 5 cm; and
the user interface is spaced forwardly from the chest-engaging member and oriented to display at least partially upwardly such that the user interface is viewable by the user.
